(19) United States
(12) Patent Application Publication
(10) Pub. No.: US 2026/0300898 A1
(43) Pub. Date: Oct. 1, 2026

(54) AI-DRIVEN SYSTEMS AND METHODS FOR LOGISTICS MANAGEMENT

(71) Applicant: Timothy G. Taylor, Minneapolis, MN (US)

(72) Inventor: Timothy G. Taylor, Naples, FL (US)

(21) Appl. No.: 19/568,159

(22) Filed: Mar. 16, 2026

Related U.S. Application Data
(60) Provisional application No. 63/771,908, filed on Mar. 14, 2025.
(60) Provisional application No. 63/827,405, filed on Jun. 20, 2025.

(51) Int. Cl. G06Q 10/0833

(52) U.S. Cl. CPC G06Q 10/0833

(57) ABSTRACT

The present disclosure is directed to machine-readable programs, and related systems and methods for management of telecommunication message routing for shipments, and related aspects.

### CROSS-REFERENCE TO RELATED APPLICATIONS

The present patent application claims the benefit of priority to U.S. Application No. 63/771,908, filed Mar. 14, 2025 and U.S. Application No. 63/827,405, filed Jun. 20, 2025. The present patent application is related to U.S. patent application Ser. No. 16/444,432, filed Jun. 18, 2019, now U.S. Pat. No. 12,192,307, issued Jan. 7, 2025, which in turn is a continuation of and claims the benefit of priority to U.S. patent application Ser. No. 14/444,544, filed Jul. 28, 2014, now abandoned, which in turn is a continuation of and claims the benefit of priority to International Patent Application No. PCT/US2013/023446, filed Jan. 28, 2013, which in turn claims the benefit of priority to U.S. Provisional Patent Application No. 61/592,186, filed Jan. 30, 2012. Each of the foregoing patent applications is incorporated by reference herein in its entirety for any purpose whatsoever.

### COPYRIGHT NOTICE

This application for letters patent disclosure document describes inventive aspects that include various novel innovations (hereinafter “disclosure”) and contains material that is subject to copyright, mask work, and/or other intellectual property protection. The respective owners of such intellectual property have no objection to the facsimile reproduction of the disclosure by anyone as it appears in published Patent Office file/records, but otherwise reserve all rights.

### BACKGROUND

Computers are used in a number of different contexts for a variety of different purposes. A user may interact with a computer to connect to the Internet, which may allow the user to complete a number of different tasks via websites. Websites information is often stored in servers, which are able to keep track of data concerning the user and the user's activity.

### SUMMARY OF THE DISCLOSURE

The purposes and advantages of embodiments of the present disclosure will be set forth in and become apparent from the description that follows. Additional advantages of the disclosed embodiments will be realized and attained by the methods, systems, computer programs and mobile computing devices particularly pointed out in the written description hereof, as well as from the appended drawings.

In a first aspect, the disclosure provides methods for AI-enhanced logistics management. In some embodiments, the method includes receiving shipment information via at least one trained AI model, the shipment information relating to a shipping task to be performed, analyzing the shipping information via at least one trained AI model to create a shipping ticket containing a plurality of fields containing shipping ticket information, and storing the shipping ticket in a shipping database.

In some embodiments, the method can further include receiving a shipping ticket request via a trained AI model. If desired, the method can further include forwarding the shipping ticket to the requestor by way of a shipping server via a trained

AI model. The shipping ticket may or may not be time sensitive.

The accompanying drawings, which are incorporated in and constitute part of this specification, are included to illustrate and provide a further understanding of the methods and systems of the disclosure. Together with the description, the drawings serve to explain the principles of the disclosed embodiments.

### BRIEF DESCRIPTION OF THE DRAWINGS

The accompanying drawings illustrate various non-limiting, example, innovative aspects in accordance with the present descriptions:

FIG. 1a shows a schematic block diagram illustrating aspects of system functionality in some of the AI LOGISTICS COMMUNICATIONS TASKING APPARATUSES, METHODS AND SYSTEMS (hereinafter “AILCT™ embodiments” or, interchangeably, “AILCT™”);

FIG. 1b shows a schematic block diagram illustrating aspects of system use and interactions in some of the AILCT™ embodiments;

FIG. 2 shows a data flow diagram illustrating an application stack for some of the AILCT™ embodiments;

FIG. 3 shows a data flow diagram illustrating creating a ticket in some of the AILCT™ embodiments;

FIG. 4a-b shows logic flow diagrams illustrating creating a ticket in some of the AILCT™ embodiments;

FIG. 5a shows a data flow diagram illustrating retrieving and selecting tickets in some of the AILCT™ embodiments;

FIG. 5b shows a data flow diagram illustrating closing a ticket in some of the AILCT™ embodiments;

FIG. 6a-b shows logic flow diagrams illustrating retrieving and selecting tickets in some of the AILCT™ embodiments;

FIG. 6c shows a logic flow diagram illustrating closing tickets in some of the AILCT™ embodiments;

FIG. 7 shows a data flow diagram illustrating ticket maintenance in some of the AILCT™ embodiments;

FIG. 8a-b shows logic flow diagrams illustrating ticket maintenance in some of the AILCT™ embodiments;

FIG. 9 shows a block diagram illustrating some aspects of a AILCT™ controller;

FIG. 10 shows a logic flow diagram of further AILCT™ embodiments; and

FIG. 11 shows a logic flow diagram of still further AILCT™ embodiments.

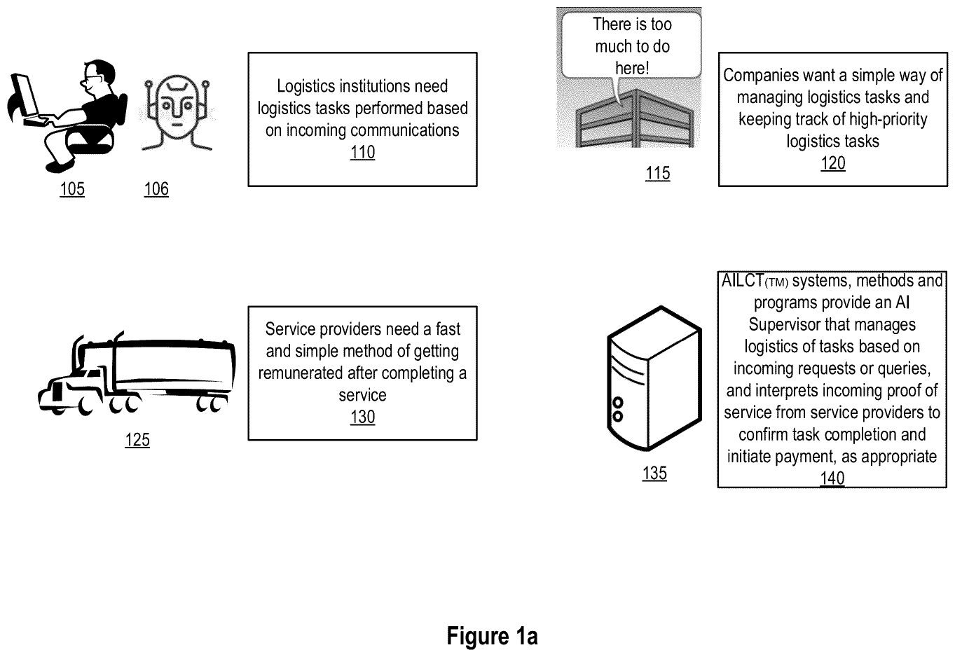

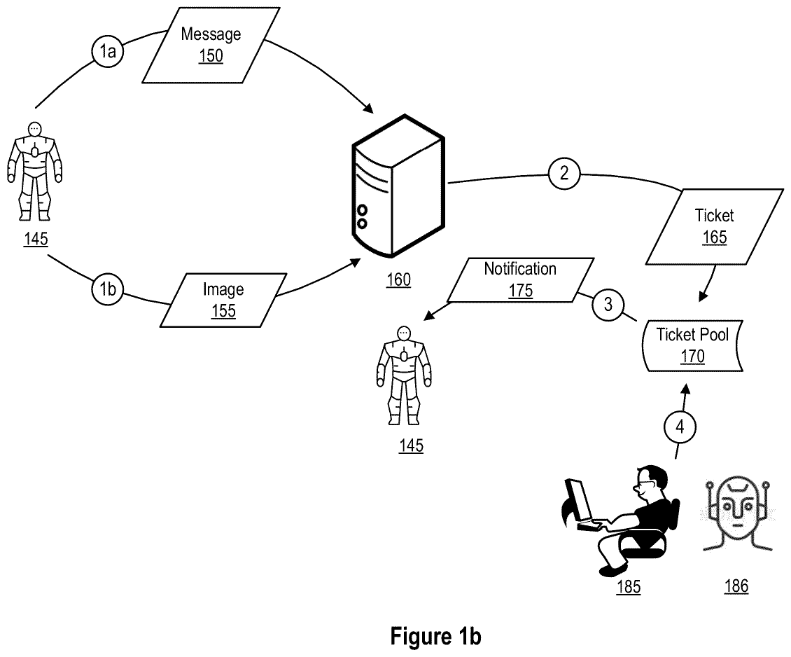

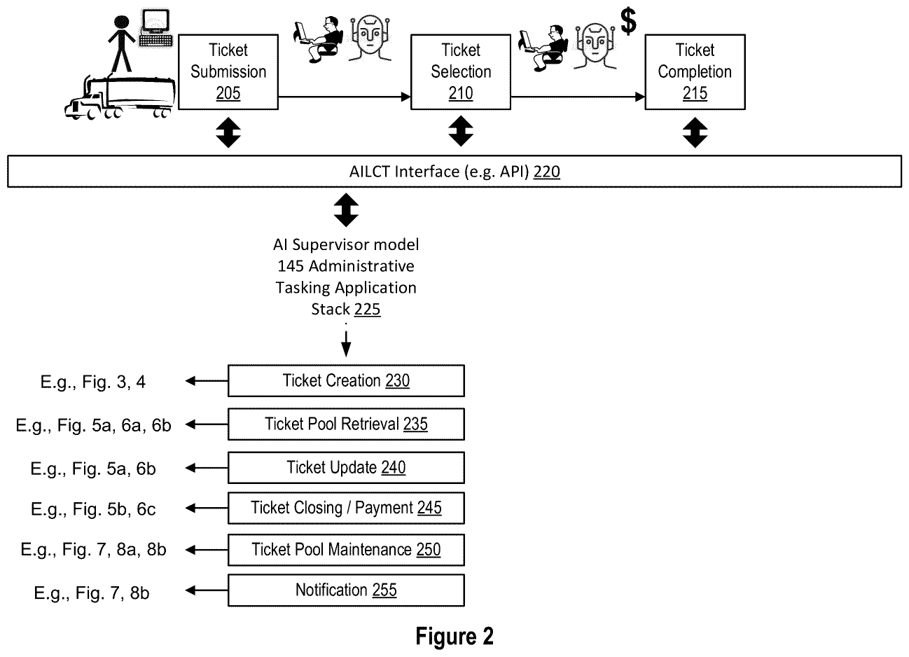

The leading number of each reference number within the drawings indicates the figure in which that reference number is introduced and/or detailed. As such, a detailed discussion of reference number 101 would be found and/or introduced in FIG. 1. Reference number 201 is introduced in FIG. 2, etc.

### DETAILED DESCRIPTION

This disclosure describes AI-enhanced apparatuses, methods, systems and machine readable computer programs for distributive on demand task systems for a variety of tasks. It is contemplated that some aspects of the methods systems and programs can be performed from a mobile computing device (e.g., smart phone or tablet, etc.).

It will be further appreciated that, while this detailed description section particularly illustrates some aspects of the disclosed systems, the illustrated principles in the figures and related text, etc. relate and enable all disclosed embodiments throughout this disclosure.

The disclosure also provides methods and systems for generating an AI model for implementing the functions set forth herein. In some implementations, the AI model is trained on data sets relating to numerous prior transactions from which the AI model may extract background data and contextual data from the data set. For example, in the below-described implementations of task management, the system is configured to receive information for a task to be performed. The system then refers the task to the AI model to permit the AI model to utilize background and contextual data to characterize, prioritize and assign the task, such as by creating and populating a task ticket to be executed by a human individual, another machine, or another AI model. In this respect, the AI model performs the function of a supervisor of the system.

It is to be understood that, depending on the particular needs and/or characteristics of a AILCT™ AI supervisor model, human employee, AI “employee”, ticket, delivery, data transmission and/or network framework and/or the like, various of the AILCT™ embodiments may be implemented that enable a great deal of flexibility and customization. The instant disclosure discusses embodiments and/or applications of the AILCT™ embodiments directed to facilitating the process of delegating and monitoring work tasks via the use of online tickets that are generated and assigned by an AI supervisor; however, it is to be understood that the apparatuses, methods and systems discussed herein may be readily adapted and/or reconfigured for a wide variety of other applications and/or implementations as set forth throughout this disclosure. Furthermore, aspects of the AILCT™ embodiments may be configured to generate, administer and/or manage a wide variety of forms of user data, geolocation data, image data, ticket-processing tools, and/or the like beyond specific embodiments and/or implementations described herein. It is to be understood that the AILCT™ embodiments may be further adapted to other implementations and/or interview and/or input-analyzing applications, and are not specifically limited to logistics tasks, but encompass any suitable tasks that may be implemented as disclosed herein.

FIG. 1a shows a schematic block diagram illustrating aspects of system functionality in some of the AILCT™ embodiments. In one embodiment, an employee 105 (or a specialty purpose task performing AI Model or bot 106) may want (or be configured to request, as appropriate) a streamlined method of obtaining work to complete 110. A supervisor 115 may want a streamlined system for delegating work to the employee or AI model, while having a system for keeping track of tasks that have been designated as high-priority, tasks that need to be verified, and/or the like 120. Truckers or other delivery or service personnel 125, such as human navigated and/or machine navigated systems benefit from streamlined systems for obtaining quick payment for deliveries they perform 130. The AILCT embodiments 135 allow the supervisor to create tickets in order to streamline the work process, allows employees to choose and complete tickets, and allows delivery personnel to initiate payment immediately after delivery by allowing them to provide proof of delivery immediately after the delivery has been performed.

FIG. 1b shows a schematic block diagram illustrating aspects of system use and interactions in some of the AILCT™ embodiments. AI models configured to function as supervisors 145 may create a ticket 165 by submitting the ticket body in a message 150 tracked by a server 160 and/or the AI supervisor 145, or by submitting an image 155, a video file in formats such as WMV, MP4, AVI, FLV, and MKV file formats, location data, a stream of digital data packets or the like, in machine parsable code such as JSON or XML, CSV files or equivalent, machine code, RDF (Resource Description Framework), SHP (Shapefile), and MARC 21 (Machine-Readable Cataloging), or binary protocols such as EbXML, HTTP/2, HTTP/3, EDOC and the like. In some implementations, the message may be an email, instant message, SMS message, and/or the like or other machine-readable communication generated and sent by a human or a machine. In some implementations, the image may be in .jpg, .bmp, gif, .png, .tiff, and/or a like format, and may contain EXIF and/or like data that may include geographic data, the date and time the image was taken, the device used to create the image, and/or like data. The server 160 and/or AI supervisor model 145 may generate the ticket under the direction of a human or AI model using contextual information from the message, image, video file, or other incoming information, and may then add it to a ticket pool 170. In some implementations, the ticket pool may contain all tickets that have not been closed yet. In some implementations, the ticket pool may only contain high-priority tickets, until all the high-priority tickets have been completed.

A human employee 185 or another task-specific AI 186 may access the ticket pool and choose a ticket to work on. The task specific AI 186 may operate independently or be used as a tool by the employee 185. The employee 185 may have access to and/or supervise multiple AI models to complete tasks for payment for the benefit of the employee. When the ticket is chosen, it may be put in the employee's or AI model's queue. The employee or AI model may close out the ticket when it has been completed. In some implementations, if the ticket has either been unselected for a specified amount of time, or it has been chosen by an employee but has not been acted upon for a specified amount of time, the AI supervisor 145 may be configured to modify the ticket and return it to the pool, such as by increasing its priority or monetary value, or delete the ticket if the AI supervisor model 145 is able to determine that the ticket has become obsolete. In some implementations, if a ticket remains idle in an employee's or other queue, it may be returned to the ticket pool.

FIG. 2 shows a data flow diagram illustrating an application stack for some of the AILCT™ embodiments. In some implementations, the AILCT embodiments may provide an API interface 220 with which other systems, and/or AI models can connect with in order to facilitate the ticket submission process 205, the ticket selection process 210, and the ticket completion process 215. When utilizing exemplary interfaces provided by the AILCT embodiments, the systems may access the Logistics Tasking Application Stack 225, which may provide a plurality of components that may include a ticket creation component 230, ticket pool retrieval component 235, ticket update component 240, ticket closing and payment component 245, ticket pool maintenance component 250, and a notification component 255.

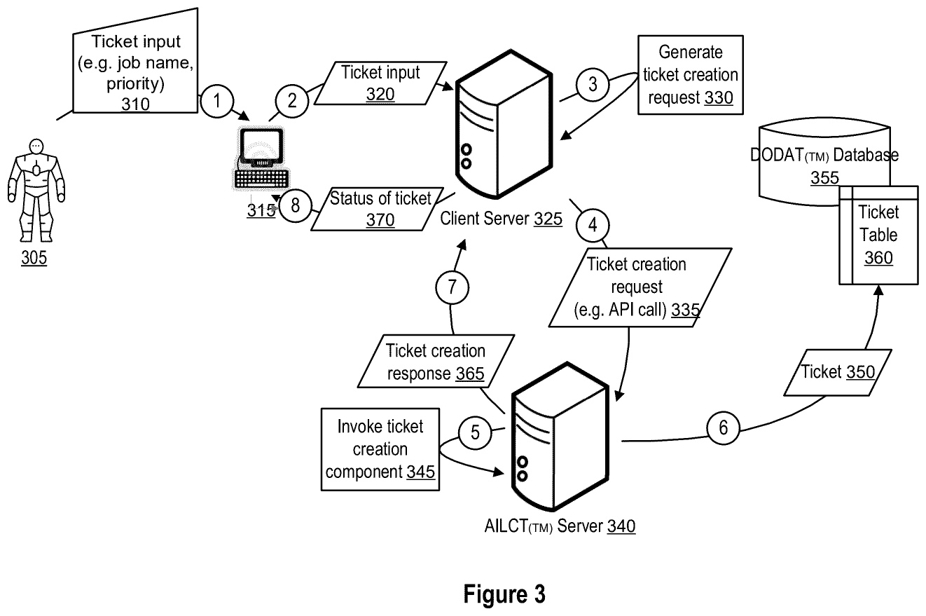

FIG. 3 shows a data flow diagram illustrating creating a ticket in some of the AILCT™ embodiments. In some implementations, an AI Supervisor model or other logistics personnel 305 may provide ticket input for a new ticket 310 in electronic, and if desired, computer readable format 315. In other implementations, the ticket input may also be provided by service personnel who have completed a service and are submitting proof of completion of service, the proof including one or more of text, image or video information, geographic coordinates, and the like. In some implementations, the electronic device may be a personal computer, a mobile phone (e.g., Apple iPhone, Samsung Galaxy, and/or the like), a tablet (e.g., Apple iPad, Samsung Galaxy Tablet, HP Touchpad, Amazon Kindle Fire, and/or the like), and/or a like device. In some implementations, the ticket input may contain information such as the name of the job or task that the ticket represents, the priority of the ticket, a due date for the ticket (if applicable), a description of the task, the companies and/or customers associated with the ticket, the amount of money the ticket is worth, any supervisors that should monitor the status of the ticket, and/or like information. In some implementations, the ticket input may be provided by server 325 or Supervisor AI model 145, 305 rather than a human supervisor (e.g., as a result of a ticket maintenance check; see FIG. 7 for further information).

The logistics personnel or AI Supervisor model 145, 305 may be able to specify the amount the ticket is worth based on the task; in some implementations, the AI supervisor may parse the ticket for keywords or particular machine code or other machine readable information, and may attempt to determine a price to assign to the ticket based on previous tickets that contained the same keywords, wherein the AI supervisor has been trained on a data set including that previous information to provide proper context for the AI model to assign an appropriate value or other attribute to the ticket. In some implementations, personnel may be able to edit the value specified for the ticket (e.g., logistics personnel or a further AI model may be able to edit the ticket value when it is clear that the ticket value specified is not high enough to entice employees to watch the ticket pool, or when the ticket has been left unclaimed for too long, and/or the like).

In some implementations, the ticket input may be passed in a message 320 to the server. In some implementations, the message may be a HTTP(S) POST message that resembles the example below, which can be generated, for example, by the AI Supervisor model 145, 305:
POST/ticketcreationrequest.php HTTP/1.1
Host: www.AILCTproccess.com
Content-Type: Application/XML
Content-Length: 788
<? XML version=“1.0” encoding=“UTF-8”?>
<ticketCreation_request>
<timestamp>2012 Jan. 6 12:30:00</timestamp>
   <ticket_params>
      <ticket_name>Return Call From Example Company</ticket name>
      <ticket_desc>John Smith from Example Company left a message regarding a recent delivery. The call should be returned as soon as possible. Phone number (555) 555-5555.</ticket_desc>
      <ticket_priority>1</ticket_priority>
      <ticket_due>2012 Jan. 6 18:30:00</ticket_due>
      <ticket_customer>John Smith, Example Company</ticket_customer>
      <ticket_value>2</ticket_value>
      <ticket_supervisors>Jane Doe</ticket_supervisors>
   </ticket_params>
</ticketCreation_request>

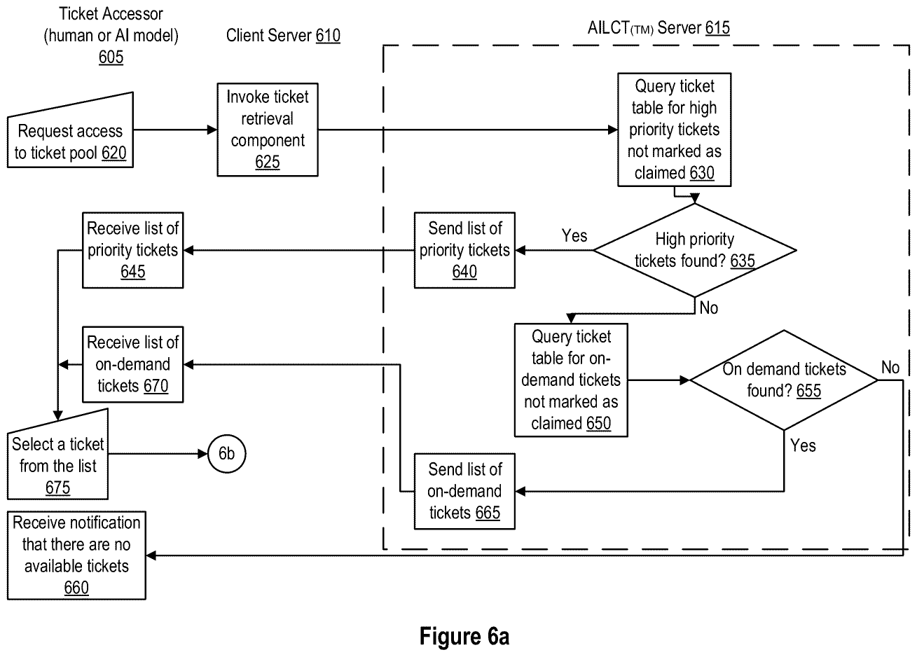

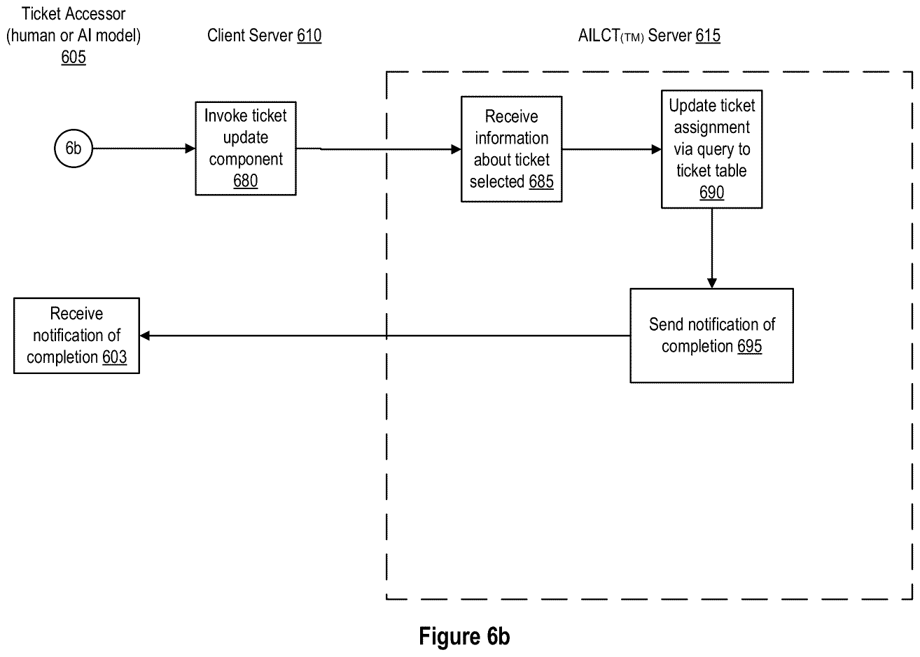

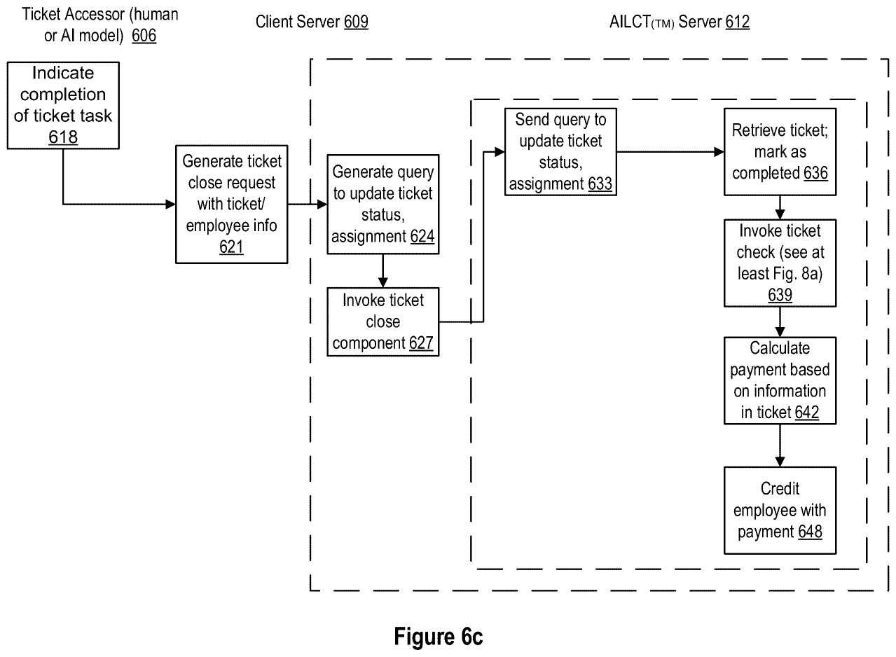

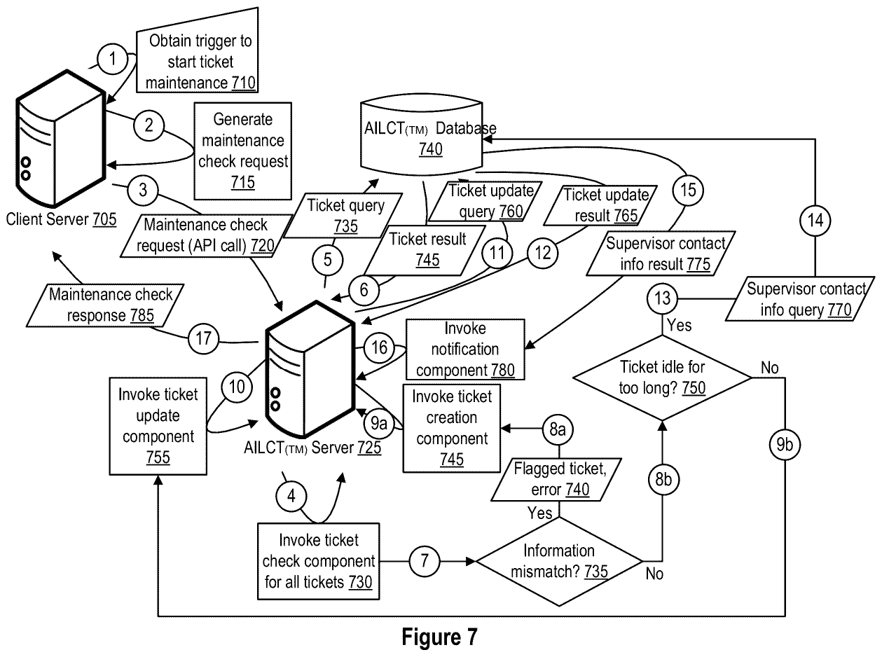

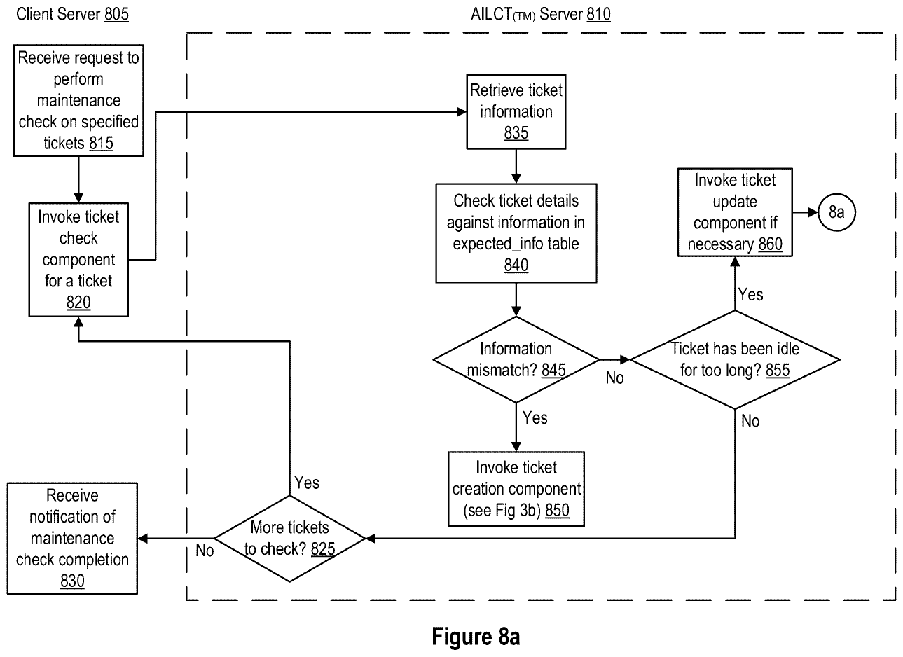

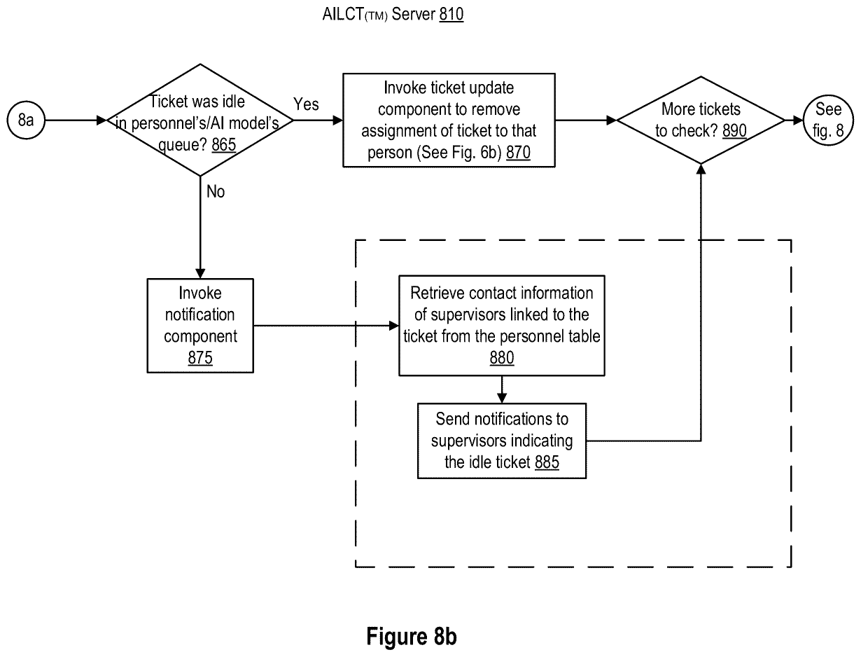

The server may generate a ticket creation request 330, which may include the ticket input, as well as a HTML request to a AILCT server 340 which may maintain the AILCT™ embodiment components. This request 335 may be sent in the form of a HTTP(S) POST message to the AILCT™ server, which may use it to invoke the ticket creation component 345. Using the ticket creation component, the AILCT™ embodiments may create a ticket 350 using the information in the ticket input. In some implementations, the ticket may also contain information such as the time the ticket was created, a ticket ID, the human ID or digital identification of an AI model that created the ticket, and/or the like. In some implementations, the ticket may also be associated with a secure key that prevents unauthorized personnel from viewing the ticket. The ticket may then be stored as a data structure in a ticket table 360 within the AILCT™ database 355. In some implementations, if the ticket is submitted from service (e.g., delivery) personnel, the AILCT™ embodiments may immediately specify the ticket as being completed (thereby initiating payment; see at least FIG. 6c), and/or may issue a request to check the details of the ticket (see at least FIG. 7). A human user or a AI model, such as the supervisor or other AI model may check the details of the ticket to look for patterns indicating that the ticket details may be inaccurate.

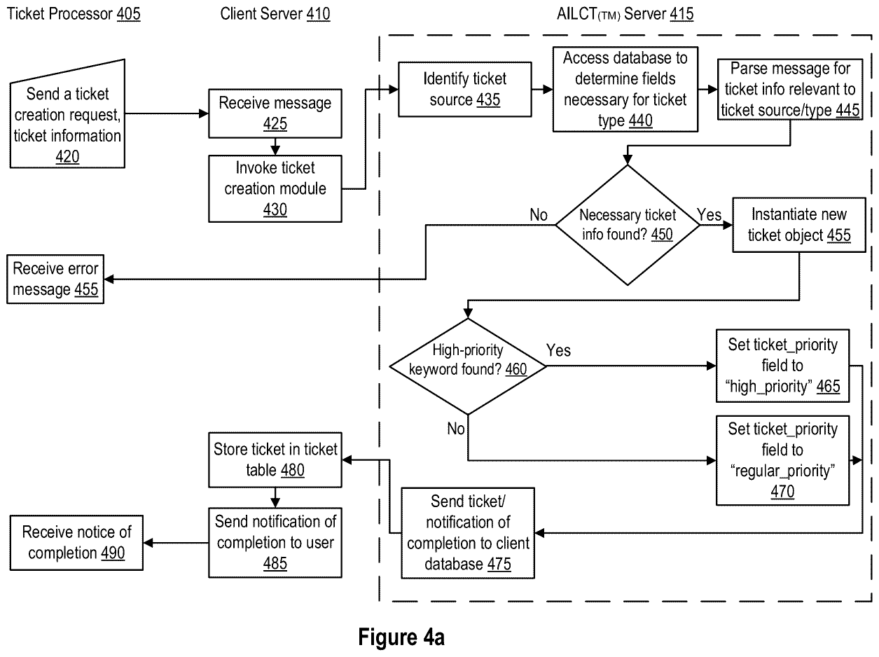

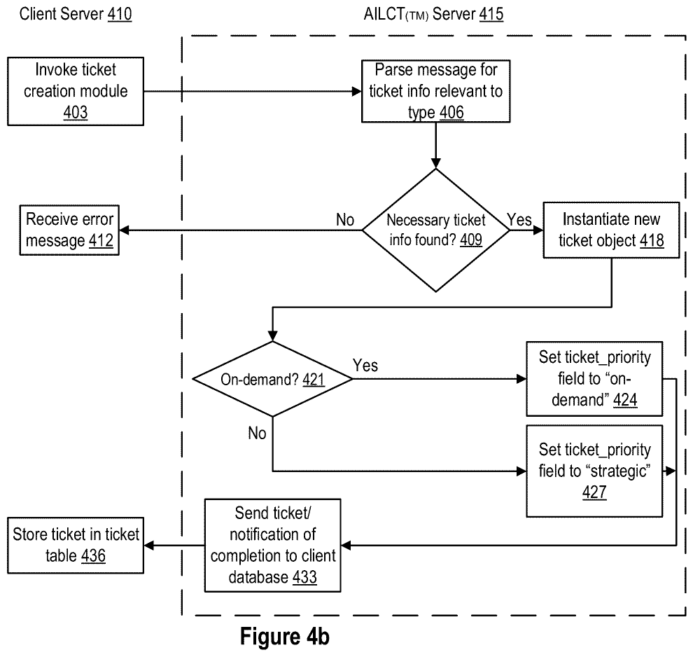

FIG. 4a shows a logic flow diagram illustrating creating a ticket in some of the AILCT™ embodiments. In some implementations, the ticket processor (e.g., the human or AI-model based supervisor or administrator creating the ticket) 405 sends a ticket creation request which includes ticket information necessary for the creation of the ticket (e.g., the ticket name, description, and/or the like) 420. The server 410 may receive this information and invoke the ticket creation module 430 within the AILCT™ server 415. The module may be conventionally programmed or may be a special-purposes AI model that is configured to identify the ticket source 435 (e.g., whether the ticket comes from a supervisor, or has been created due to a completed delivery, and/or the like). Based on what the ticket source is, the AILCT™ server may access the AILCT™ database in order to determine the fields necessary to complete the appropriate ticket for the task (e.g., determine whether a due date is required based on the source of the ticket, and/or the like). The AILCT™ embodiments may parse the ticket input received 445 for machine readable code in order to make sure the proper information has been provided 450. For example, if the ticket has come from a delivery personnel's mobile device, the AILCT™ embodiments may determine whether an image, video data, location data, or machine code is included in the message, and whether the image contains EXIF or other data. An AI model within the AILCT™ embodiments may compare the ticket data for expected information based on being trained on a dataset of prior ticket data including data evidencing valid tickets and invalid tickets. If the AI model identifies patterns consistent with an invalid ticket, the AILCT™ embodiments may send an error message to the ticket processor indicating that the ticket input did not contain required information 445.

If all the necessary information has been found in the ticket input, the AILCT™ embodiments, and/or a suitable trained AI model therewithin may instantiate a new ticket object 455 using the information in the ticket input. The AILCT™ embodiments including a suitably trained AI model may then parse the ticket input for a high-priority keyword 460. In some implementations, the keyword may be “high-priority,” “priority,” “urgent,” and/or a like term. If such a term is found, the ticket is set to have a high priority 465; if the term is not found, then the ticket is specified as a regular priority ticket 470. In some implementations, high-priority tickets may be available to employees before all other ticket types, and employees may not be able to complete regular priority tickets until all high-priority tickets have been taken and/or completed, in order to ensure the more important tasks are completed. The AILCT™ server may then send the ticket object and a notification of completion to the client server 475. In some implementations, the ticket may be stored in a ticket table of a database in the server 480. The notification may then be forwarded to the ticket processor 485, who may receive the notification that the ticket creation process has been completed 490.

FIG. 4b shows a logic flow diagram illustrating creating a ticket in further AILCT™ embodiments, which may be invoked by a suitably trained AI model for that purpose. In some implementations, the client server 410 under the direction of the AI model will create tickets to add to the queue. These tickets may be in response to maintenance checks, can be tickets that the server is scheduled to make in intervals (e.g., for the purpose of status-checking orders, performing reviews of other employees, and/or the like). The client server may invoke the ticket creation module 403, which may involve sending a message to the AILCT™ server 415, indicating that a ticket should be made, and indicating the numerous pieces of information necessary to create the ticket (e.g., the ticket name, ticket date, ticket value, ticket description, and/or the like). In some implementations, logistics personnel may specify how much certain tickets created by the client server should be worth; in other implementations, the server may choose a value for the ticket under the direction of a suitably configured AI model trained on similar data from prior tickets, based on parameters specified by the logistics personnel or another AI model (e.g., the maximum and minimum value for such tickets, the average value of accepted tickets, and/or like information).

The AILCT™ server may receive the message and parse it to find information necessary to create the ticket 406. If the AILCT™ server cannot find all of the necessary information 409, it may send an error message back to the client server 412, which may indicate the information that was missing. If the AILCT™ server is able to find the relevant information, then the server may instantiate a new ticket object 418 under direction of an AI model trained on similar prior data using the information found in the message. In some implementations, the message may also specify a priority for the ticket: if there is a keyword in the message to specify the ticket as being on-demand 421, then the server will automatically set the priority of the ticket to “on-demand” 424. If a keyword is not found, then the ticket may be set to “strategic” priority 427.

In some implementations, on-demand and strategic-priority tickets may only be available for human or AI-model workers to claim when there are not enough high or regular-priority tickets in the ticket pool; in other implementations, on-demand and strategic-priority tickets may only be added to the pool at certain times of the day, at specified intervals over an entire day, and/or the like. In some implementations, on-demand tickets may include tickets related to maintenance checks and/or any work that should be completed but is not time-sensitive. In some implementations, strategic tickets may include status check tickets, and/or any work that is not important to complete and does not have a deadline. In some implementations, the number of strategic tickets released to the queue may be limited to an amount specified by a human administrator or under direction of an AI model trained on similar prior data. In some implementations, the on-demand and strategic-priority tickets may be released in this manner for the purpose to keeping employees occupied during busy times of the day, while making sure the ticket pool is not over-crowded with tickets during less busy work times. The release schedule may also prevent employees from only visiting the ticket pool at certain times of day, as the release schedule may be changed to suit work demand on a day-by-day basis. The timing of release of tickets can be enhanced by training an AI model in charge of ticket distribution on prior ticket data.

In some implementations, after the priority of the ticket has been established, the ticket, and a notification of completion, may be sent to the client database 433.

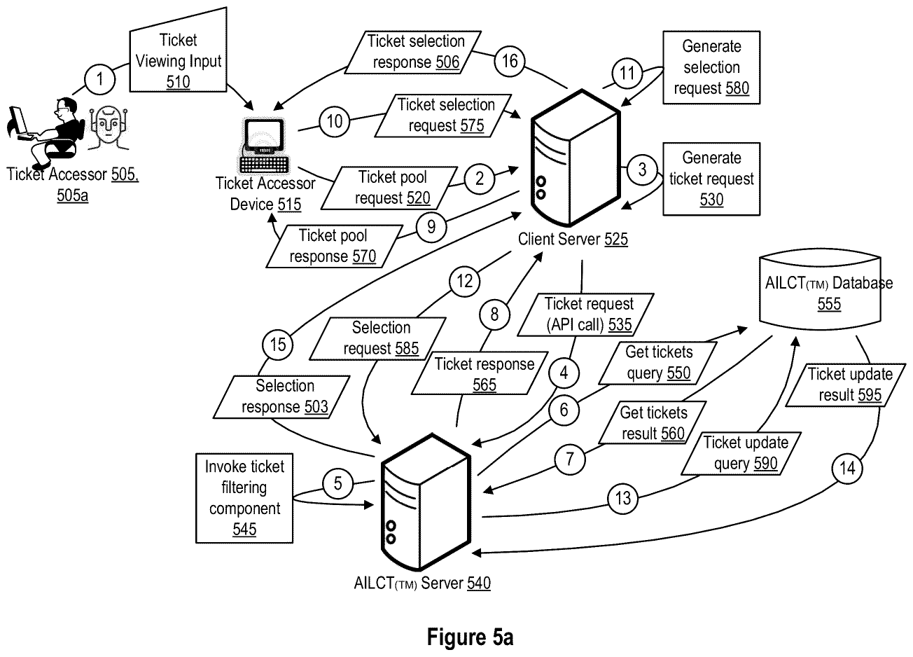

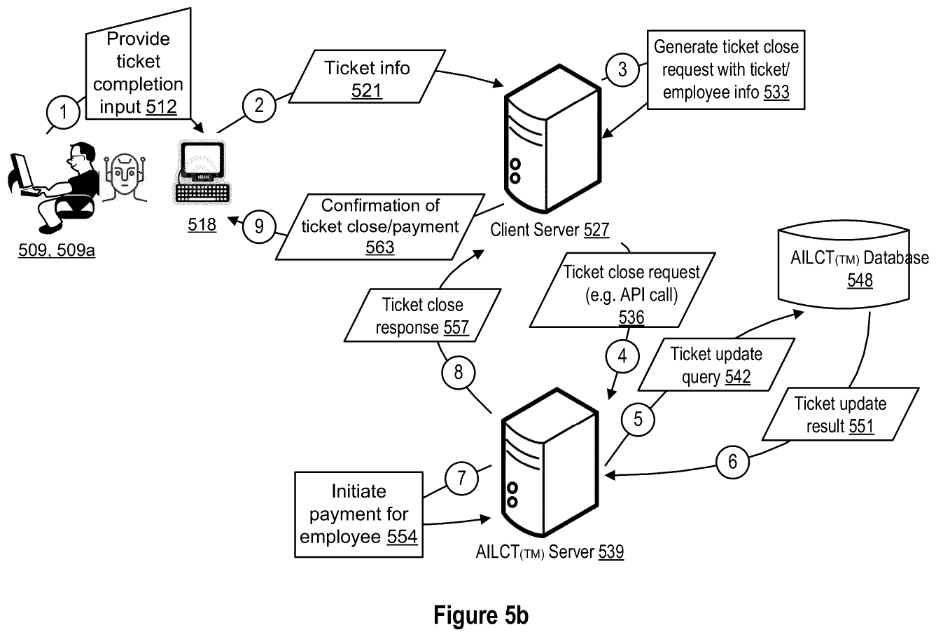

FIG. 5a shows a data flow diagram illustrating retrieving and selecting tickets in some of the AILCT™ embodiments. In some implementations, a ticket accessor 505 (human) and/or 505a (e.g., trained AI model) may provide input 510 to an electronic device 515, in order to access the ticket pool and select a ticket. The electronic device may send a ticket pool request to the client 525. In some implementations, the request may be an HTTP(S) POST message that resembles the following:
POST/ticketpoolrequest.php HTTP/1.1
Host: www.AILCTproccess.com
Content-Type: Application/XML
Content-Length: 788
<? XML version=“1.0” encoding=“UTF-8”?>
<ticketPool_request>
<timestamp>2012 Jan. 6 12:30:00</timestamp>
   <personnel_params>
      <personnel_ID>12345abCD</personnel_ID>
      <personnel_name>John Smith</personnel_name>
      <personnel_type>employee</personnel_type>
      <personnel_company>MyCompany</personnel_company>
      <personnel_tickets>1234, 5678</personnel_tickets>
   </personnel_account_params>
</ticketPool_request>

The client may then generate a ticket retrieval request 530, which may access an API call 535 to the AILCT™ server 540, wherein operation of the server 540 may be under the direction of a AI model trained to operate the server based on being trained by prior relevant background and contextual data. The AILCT™ server, which may include a suitably trained AI model, may thus use the information provided in the ticket pool request to filter tickets based on the user information (e.g., the user's company, the user's rank, the number of tickets the user is already working on, and/or the like). The AILCT™ server may send a query for these tickets 550 to the AILCT™ database 555. The AILCT™ database may return the set of tickets via a query result 560, which may be sent to the client via a response to the ticket request 565. The client may then send a ticket pool response 570 to the electronic device of the ticket accessor. The AILCT™ embodiments may then present the tickets to the ticket accessor in the form of a ticket pool, where the ticket accessor may choose a ticket to complete. If the ticket accessor selects a ticket, a ticket selection request 575 may be sent from the ticket accessor's electronic device to the client. The client may generate a selection request 580, which may be sent 858 to the AILCT™ server. The AILCT™ server may then initiate a query 590 to update the ticket to indicate that a new owner has been assigned to the ticket. The result of the ticket update 595 may be provided to the AILCT™ server, which may then send a selection response 503 to the client, which may in turn send a ticket selection response 506 to the ticket accessor's electronic device. In some implementations, the ticket selection response may comprise a message to the ticket accessor indicating the ticket selection was successful.

FIG. 5b shows a data flow diagram illustrating closing a ticket in some embodiments of the AILCT™ embodiments. In some implementations, the ticket accessor (e.g., employee or AI model(s)) 509, 509a may provide ticket completion input 512 to an electronic device 518. In some implementations, the ticket completion input may be selecting a “close” option on a ticket viewing page. The AILCT™ embodiments may then send a ticket information message 521 to the client server 527; in some implementations, the message may be in the form of a HTTP(S) POST message. The client server may then generate a ticket close request 533, using the information from the ticket and the ticket accessor closing the ticket. The client may then send a ticket close request 536 to the AILCT™ server 539. The AILCT™ server may send a query 542 to the AILCT™ database 548 in order to update the status of the ticket (e.g., to mark it as “closed”). Once the AILCT™ server has received a successful update result 551 from the AILCT™ database, the AILCT™ server may initiate payment for the ticket accessor who completed the ticket task 554. In some implementations, initiating payment may involve accessing the ticket accessor's online payment information (e.g., direct deposit information), creating a ticket for preparing and mailing a physical check to the ticket accessor, and/or the like. In some implementations, initiating payment may involve crediting the ticket accessor with the value of the ticket being closed, and withholding actual payment until a specified amount has been credited to the ticket accessor (e.g., crediting a ticket accessor's account until the ticket accessor has earned at least $50, and/or some like value). The AILCT™ server may also send a ticket close response 557 to the client server to indicate that the ticket update has been completed. The client may send a ticket information response 563 to the ticket accessor, which may include confirmation that the ticket has been closed, as well as confirmation that payment has either been initiated or completed.

FIGS. 6a-b show logic flow diagrams illustrating retrieving and selecting tickets in some embodiments of the AILCT™ embodiments. In some implementations, the ticket accessor 605 may request access to the ticket pool 620. In some implementations, accessing the ticket pool may involve accessing a ticket pool interface that displays all available tickets for the ticket accessor to complete. When the ticket accessor requests access to the ticket pool, a message may be sent to the client server 610, which may invoke the ticket pool retrieval component 625. The ticket pool retrieval component may query the ticket table of the AILCT™ database on a AILCT server 615, which may involve searching the table for high-priority tickets that have not been claimed by other ticket accessors 630. In some implementations, tickets may be further filtered by the position the ticket accessor holds, tickets the ticket accessor has successfully completed before, and/or the like.

If high-priority tickets are found in the ticket table 635, then the AILCT™ server may send a list of references to the high-priority tickets that match the filtering parameters 640 to the server. If high-priority tickets are not found in the ticket table, the AILCT™ server may then query the ticket table for other priority tickets that are not marked as claimed 650. The AILCT™ server may also filter tickets based on parameters described above, and/or the like. References to the non-priority tickets may then be sent back to the server 665. If the ticket table also does not contain any non-priority tickets that match the filtering parameters, the ticket accessor may be sent a notification indicating that there are no available tickets to work on 660.

The server may then display the referenced high-priority 645 or on-demand 670 tickets in the interface that the ticket accessor is viewing the ticket pool from may. The ticket accessor may then select one of the tickets displayed in the ticket pool 675, initiating a process that may prompt the client server 610 to invoke the ticket update component 680. This component may receive the information about the ticket the ticket accessor selected 685, and may then query the ticket table of the AILCT™ database in association with the AILCT™ server 615 in order to find the ticket and update its status (e.g., to “claimed”) and its owner (e.g., the ticket accessor) 690. In some implementations, the AILCT™ server may also send a notification of completion 695 to the ticket accessor, who may receive the notification of completion 603 via the ticket pool interface. In some implementations, a notification may also be sent to any supervisors linked to the ticket, and may include information as to who claimed the ticket, the date and time it was claimed, and/or the like.

FIG. 6c shows a logic flow diagram illustrating closing tickets in some of the AILCT™ embodiments. In some implementations, a ticket accessor 606 may indicate that he has completed a task specified by a ticket 618. In some implementations, the ticket accessor may achieve this by viewing the ticket in a ticket viewing interface, and editing information regarding the ticket (e.g., choosing a “closed” option, entering in a description of what actions were performed in order to complete the ticket, and/or the like). Once the ticket accessor has submitted that the task has been completed, a ticket close request may be generated 621, which may possess information about the ticket being closed and the ticket accessor closing the ticket. The client server 609 may generate a query to the ticket table in the AILCT™ database on the AILCT™ server 612, in order to update the ticket information 624. Doing so may invoke a ticket close component 627, which may send this query to the AILCT™ server. The AILCT™ server may then retrieve the ticket 636 and may update the ticket information (e.g., marking the ticket as completed, indicating the time and date the ticket accessor completed the ticket, and/or the like). The AILCT™ server may invoke a ticket check 639 (see FIG. 8a) in order to determine whether the ticket has been satisfactorily completed; if the closed ticket clears the ticket check, the AILCT™ server may then calculate payment for the ticket accessor 642 based on the ticket value provided in the ticket information. The AILCT™ embodiments may then credit the ticket accessor with the payment 648.

In some implementations, crediting the ticket accessor may involve sending the ticket accessor the payment for the ticket task. In some implementations, this may involve retrieving financial information (e.g., a direct deposit account) that may be used to electronically provide the ticket accessor with the funds via direct depositing procedures. The AILCT™ embodiments may use the financial information to determine the financial institution that the ticket accessor uses, and may send a request to the financial institution (e.g., via an API call to the financial institution's server) to update the ticket accessor's account balance with the payment from the ticket task. The AILCT™ embodiments may also save a record of the payment in the transactions table of the AILCT™ database. In other implementations, if the ticket accessor does not possess an account that supports direct deposit, the AILCT™ embodiments may retrieve enough information (e.g., the name of the ticket accessor, the amount of the transaction, the ticket accessor's address, and/or the like) to create a ticket indicating that personnel should write a physical check, money order, and/or the like for the ticket accessor, and should mail it to the ticket accessor's address. In some implementations, the ticket created may be a regular-priority or on-demand ticket.

In other implementations, crediting the ticket accessor may involve crediting a ticket accessor account with the value of the ticket. In such implementations, the personnel account for the ticket accessor may include an account_balance field that may keep track of how much money has been credited to the ticket accessor by the AILCT™ embodiments. In some implementations, records of each credit may also be stored in the transactions table of the AILCT™ database. After a specified amount of money has been credited to the ticket accessor (the specified amount being chosen by the ticket accessor, by logistics personnel, and/or the like), the AILCT™ embodiments may automatically initiate actual payment to the ticket accessor using at least the techniques described above.

FIG. 7 shows a data flow diagram illustrating ticket maintenance in some of the AILCT™ embodiments. In some implementations, the server 705 may receive a trigger to start ticket maintenance 710. In some implementations, the trigger may be a scheduled maintenance check on all tickets, a ticket processor-prompted ticket check, a ticket close procedure, and/or the like. These processes may be managed by an AI model resident on the server 705 or elsewhere to manage the process, wherein the AI model has been trained on training data that may include records of prior transactions. Receiving a trigger may initiate generating a maintenance check request 715, which may comprise information about specific tickets to be checked, if only some tickets are to be checked. The server may then send a maintenance check request 720 to the AILCT™ server 725, which may prompt the AILCT™ server to invoke a ticket check component for all the tickets 730. In some implementations, the ticket check component may only be invoked for specified tickets. The AILCT™ server may then query 735 the AILCT™ database 740 in order to access a ticket to be checked, and send the result of the query 745 to the AILCT™ server. The AILCT™ database may also contain information as to what details should be in the ticket to be checked, and these details may also be sent with the result of the query. The AILCT™ server may then compare the information in the ticket to be checked with the information that should be in the ticket, in order to determine whether the ticket being checked has incorrect information 735.

If the information does not match, then the ticket may be flagged as a ticket with a potential error in it, and an error may be sent to the AILCT™ server 740. For example, if a delivery personnel submits a proof of delivery (and thus creates a ticket in the system), and the geolocation data in the proof of delivery image indicates that the delivery personnel submitted the document a state away from the expected delivery location, the AILCT™ embodiments may flag the ticket submitted by the delivery personnel. In some implementations, flagging the ticket may involve changing a boolean value within the ticket to indicate that it is flagged. When a ticket is flagged, the AILCT™ server may invoke the ticket creation component 745, which may create a ticket indicating that the flagged ticket needs to be reviewed by human personnel.

If the human personnel determine that the flagged ticket is correct, the ticket may be unflagged. In some implementations, this can involve closing the ticket prompting the personnel to review the flagged ticket, which may in turn unflag the flag ticket automatically; in other implementations, the human personnel may manually unflag the ticket. If the human personnel determine that the flagged ticket does contain errors, they may be prompted to rectify the discrepancies in the ticket, to complete the ticket task a second time, and/or a like action. For example, if a human personnel verifies that the proof of delivery does seem to have been submitted from a location different from the expected delivery address, the personnel may be prompted to create tickets to call the delivery personnel to get more information on the delivery, to call the client and determine if the delivery made it to the right destination, and/or the like. The personnel may also be prompted to cancel any payments that have been issued to the delivery personnel who completed the task.

If the information in the checked ticket matches the information that the ticket should contain, the AILCT™ embodiments may then check to determine whether the ticket has been idle for too long 750. In some implementations, the amount of idle time allowed may be specified on a per-ticket basis; in some implementations, it may be specified based on the priority of the ticket (e.g., a high-priority ticket may allow an idle time of a minute, while a regular ticket may be allowed to be idle for five minutes, and/or the like). If the ticket has been idle for too long, a query may be sent to the AILCT™ database in order to obtain the contact information of the ticket processor(s) responsible for the ticket 770. The process may also be managed by a trained AI model that identifies patterns in ticket idleness over time and based on the data may determine a suitable time interval for a ticket to be idle before taking action. The AILCT™ database may return the contact information in a ticket processor contact information result 775 from the database, which may prompt the AILCT™ server to invoke a notification component 780 that sends a message to the ticket processor indicating that the ticket has been left idle for too long. If the ticket has not been idle for too long, then the ticket may be updated through the ticket update component 755, which may send a ticket update query 760 to the AILCT™ database in order to indicate that the ticket has been cleared in the maintenance check. In some implementations, information as to when the ticket was checked may be stored in a log that may keep track of discrepancies found in each of the tickets in the AILCT™ embodiments. The AILCT™ database may then send a ticket update result 765 to the AILCT™ server, which may then repeat the process of checking tickets until the last ticket has been checked. Once the last ticket has been checked, the AILCT™ server may send a maintenance check response 785 to the server 705, indicating that the maintenance check has been completed. In some implementations, the response may also contain information as to how many tickets contained discrepancies, the ticket accessors and processors associated with the tickets that contained discrepancies, and/or the like.

FIGS. 8a-b show logic flow diagrams illustrating ticket maintenance in some of the AILCT™ embodiments. In some implementations, the server 805 may receive a request to perform a maintenance check on specified tickets 815. In some implementations, the specified tickets may be a subset of the total tickets. In other implementations, the specified tickets may include all tickets in the AILCT™ database. The server may invoke a ticket check component for each ticket 820. The ticket check component may retrieve ticket information 835 in the ticket table of the AILCT™ database within the AILCT™ server 810; the ticket check component may also access information in a expected_info table 840, which represents information that should be in the ticket in the ticket table. For example, if the ticket being checked is supposed to contain proof of a delivery scheduled for a particular day in a particular location, the information linked to the ticket in the expected_info table may specify the time and location that should be present in the EXIF data present in the image within the proof of delivery ticket. The AILCT™ server may check the information in the ticket against the information retrieved from the expected_info table. If there is a mismatch in the information 845, the AILCT™ server may flag the ticket as being in error, and may invoke the ticket creation component 850 in order to make a ticket with instructions to check the flagged ticket. If there is no mismatch, the AILCT™ server may check to determine whether the ticket has been left idle for too long 855. If it has not been left idle for too long, then the AILCT™ server may check to determine whether there are more tickets to check 825, and may either invoke the ticket check component for the next ticket to be checked 820, or may send a notification to the server indicating that the maintenance check has been completed 830. If the ticket has been left idle for too long, then the AILCT™ server may invoke the ticket update component 860. In some implementations, if the ticket was left idle in a ticket accessor's queue 865, the AILCT™ server 810 may remove assignment to the ticket accessor and to return the ticket to the ticket pool 870. If the ticket was left idle, but was not assigned to a ticket accessor's queue, the AILCT™ server may invoke a notification component 875, which may retrieve the contact information of ticket processors linked to the idle ticket 880. In some implementations, the contact information may be retrieved from the personnel table in the AILCT™ database on the AILCT™ server. The AILCT™ server may then send notifications to the ticket processors linked to the idle ticket, indicating that the ticket has been left idle for too long 885. In other implementations, the ticket update component may be invoked if the ticket has a close deadline; in such instances, the AILCT™ embodiments may elevate the priority of the ticket. The AILCT™ server may then determine whether there are more tickets to check 890; if there are more tickets, the AILCT™ server may check the next ticket 820; otherwise it may send a notification to the server indicating that the maintenance check was completed 830.

### AILCT™ Controller and AI Model Training

FIG. 9 shows a block diagram illustrating embodiments of a AILCT™ controller 901. In this embodiment, the AILCT™ embodiments controller 901 may serve to aggregate, process, store, search, serve, identify, instruct, generate, match, and/or facilitate interactions with a computer through internet technologies, and/or other related data. The controller may house one or more trained AI models that are trained on suitable data sets to permit the models to carry out the various system functions described in the present disclosure.

Typically, users, which may be people and/or other systems or trained AI models, may engage information technology systems (e.g., computers) to facilitate information processing. In turn, computers employ processors to process information; such processors 903 may be referred to as central processing units (CPU). One form of processor is referred to as a microprocessor. CPUs use communicative circuits to pass binary encoded signals acting as instructions to enable various operations. These instructions may be operational and/or data instructions containing and/or referencing other instructions and data in various processor accessible and operable areas of memory 929 (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations. One type of program is a computer operating system, which, may be executed by CPU on a computer; the operating system enables and facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the AILCT™ controller 901 may be connected to and/or communicate with entities such as, but not limited to: one or more users from user input devices 911; peripheral devices 912; an optional cryptographic processor device 928; and/or a communications network 913.

AI models utilized by the AILCT™ system may be trained on datasets from prior transactions of the AILCT™ system or other systems. This training data, and other data utilized by the system (relating to any task or function described herein) may be vectorized by converting data (such as text, images, encoded video data, and the like) into numerical vectors, enabling AI models to understand and process the data effectively. This process permits the AI models to learn patterns and make predictions based on these numerical representations. These predictions can in turn be used to carry out most, if not all, functions of the AILCT™ system.

In machine learning, data is often represented and organized using vectors. Each data point is typically represented as a vector, with each component of the vector representing a feature or attribute of the data. This vector representation allows machine learning algorithms to process and analyze the data effectively. By organizing data into vectors, machine learning models can perform various operations on the data, such as clustering, classification, and regression. Vectors enable algorithms to leverage mathematical operations, such as calculating distances and similarities, to make predictions and learn patterns within the data. In neural networks, vectors are often used as inputs, where each layer of the network transforms the input vector into a higher-dimensional representation. These transformations allow the model to learn complex patterns and relationships, leading to more accurate predictions.

Text vectorization techniques like “Bag of Words” or “TF-IDF” convert text into numerical vectors by counting the frequency of words or terms in a document. Images can be vectorized by representing each pixel's intensity as a number, creating a vector where each element corresponds to a pixel. Numerical data is often represented as vectors with each element corresponding to a specific numeric value. These techniques can be used to vectorize each type of data described in the present disclosure to train AI models to carry out the various functions discussed in the present disclosure.

In some cases, feature extraction may reduce dimensionality of representation and may make the recognition process computationally more efficient. In some cases, extracted feature can be compared with an abstract vector-like representation of a character, which might reduce to one or more glyph prototypes. General techniques of feature detection in computer vision are applicable to this type of OCR. In some embodiments, machine-learning processes like nearest neighbor classifiers (e.g., k-nearest neighbors algorithm) can be used to compare image features with stored glyph features and choose a nearest match. OCR may employ, for example, Cuneiform and Tesseract. Cuneiform is a multi-language, open-source optical character recognition system originally developed by Cognitive Technologies of Moscow, Russia. Tesseract is free OCR software originally developed by Hewlett-Packard of Palo Alto, California, United States.

In some cases, OCR may employ a two-pass approach to character recognition. Second pass may include adaptive recognition and use letter shapes recognized with high confidence on a first pass to recognize better remaining letters on the second pass. In some cases, two-pass approach may be advantageous for unusual fonts or low-quality image components where visual verbal content may be distorted. Another exemplary OCR software tool includes OCRopus. OCRopus development is led by German Research Centre for Artificial Intelligence in Kaiserslautern, Germany.

In some cases, OCR may include post-processing. For example, OCR accuracy can be increased, in some cases, if output is constrained by a lexicon. A lexicon may include a list or set of words that are allowed to occur in a document. In some cases, a lexicon may include, for instance, all the words in the English language, or a more technical lexicon for a specific field. In some cases, an output stream may be a plain text stream or file of characters. In some cases, an OCR process may preserve an original layout of visual verbal content. In some cases, near-neighbor analysis can make use of co-occurrence frequencies to correct errors, by noting that certain words are often seen together. For example, “Washington, D.C.” is generally far more common in English than “Washington DOC.” In some cases, an OCR process may make us of a priori knowledge of grammar for a language being recognized. For example, grammar rules may be used to help determine if a word is likely to be a verb or a noun. Distance conceptualization may be employed for recognition and classification. For example, a Levenshtein distance algorithm may be used in OCR post-processing to further optimize results.

Developing training data for AI models to carry out the disclosed implementations may be created by converting a user dataset of prior system data into a cleansed data format. As used in this disclosure, a “cleansed data format” is a format and/or structure for data where the data is transformed from an unprocessed format and/or structure into a processed format and/or structure that is prepared for use in the generation and training of an artificial intelligence (AI) model, for example a machine learning model, a neural network, and the like. A cleansed data format may be used to ensure data used for the generating and training of the AI model is relevant and accurate to generate an optimal AI model. A cleansed data format may also include data that is transformed by constructive transformation, destructive transformation, and/or structural transformation into the process format and/or structure. In some embodiments, constructive transformation of data may include adding data, replicating data, and the like. In some embodiments, destructive transformation of data may include fixing or removing incorrect, corrupted, incorrectly formatted, duplicate, or incomplete data within a dataset, and the like. In some embodiments, structural transformation of data may include moving and/or combining columns of data in a data set, and the like. The converting of data may include the processing, cleansing, standardizing, and categorizing of data into a cleansed data format for use in generating an accumulated artificial intelligence (AI) model. In an embodiment, the converting of the user dataset may include the processing, cleansing, and standardizing of data into a data set and/or data bucket for use in generating an artificial intelligence model.

The converting of a user dataset may include parsing each data set of the plurality of data sets and each header of a plurality of headers of the plurality of data sets into parsed data. As used in this disclosure, a “header” is a part of a data set that carries metadata or other information necessary for processing the main data. In an exemplary embodiment, the header may be used to describe the length of the content or other characteristics of the file. For example, the AILCT™ controller 901 may be configured to determine each header of data within each received data set and determine which data is associated with each respective header. In an embodiment, the AILCT™ controller 901 may be configured to automatically determine a header based on a recognized header from a previous data set. In one exemplary embodiment, the AILCT™ controller 901 may be configured to determine at least one header of the user dataset may be similar to a recognized header from a previous data set.

The AILCT™ controller 901 may be configured to extract a plurality of background data from the user dataset. As used in the current disclosure, “background data” refers to descriptive or informational data that provides details about other the user dataset. In some cases, background data may include meta data. Background data may include descriptive metadata, wherein descriptive metadata is configured to describes the content, context, and structure of the data. This may include information such as time, geographic location, previous queries associated with user, user job descriptions, historical preference of the user, and the like. Background data may be used to describe records of how the data has been accessed, utilized, or modified over time, aiding in understanding data usage patterns, and optimizing access. In some embodiments, background data may provide details regarding the management and administration of the data, such as access rights, permissions, versioning, and preservation information. It includes information such as titles, authors, dates, keywords, and abstracts data or information that is collected, processed, or generated passively in the background without requiring direct input or actions from the user. This data is often gathered by applications, devices, or systems for various purposes, such as improving user experiences, enhancing functionality, or aiding in analytics. Background data may be extracted from the user dataset using various methods and techniques depending on the type and structure of the data. In some cases, data profiling tools automatically analyze the dataset to extract metadata, including statistical summaries (e.g., min, max, mean, standard deviation), data distributions, unique values, and data quality metrics. Profiling tools can help understand the data's characteristics and identify anomalies. Additionally, Software tools may be used to analyze the data to infer its underlying schema or structure. This process involves identifying data types, keys, relationships, and constraints based on patterns and regularities within the dataset.

Natural language processing (NLP) techniques can be used to extract metadata such as keywords, entities, topics, and sentiment analysis. NLP algorithms can automatically annotate and categorize text, providing valuable metadata about the content. Machine learning algorithms can be trained to identify and extract specific metadata elements from the dataset. For example, a model can be trained to recognize dates, names, or numerical values within the dataset. For datasets sourced from the web, web scraping techniques, mentioned herein above, can be employed to extract metadata from web pages. This can include extracting information about the source, publication date, author, or any other relevant metadata present on the web. Background data can be extracted from the user dataset utilizing APIs and data catalogs associated with specific datasets or data sources can provide standardized metadata. APIs often offer programmatic access to metadata and dataset information.

In accordance with further aspects, the AILCT™ controller 901 may be configured to extract a plurality of contextual data from the a user dataset. As used in the current disclosure, “contextual data” refers to additional information or details that provide a more comprehensive understanding of a current situation. This additional information helps in interpreting and making sense of the user dataset in a specific context. Contextual data may be essential for accurately analyzing, utilizing, and deriving insights from the primary data. Contextual data may be directly relevant to a particular situation, event, or entity. It provides the necessary background and details to understand the data's significance in that specific context. In some cases, contextual data may be used to provide temporal context to a user query or the user dataset. This may include timestamps, time of day, day of the week, or any other temporal details that help establish when the data was generated or relevant to a particular moment. This may include the order/timing in which events or queries occurred. In some embodiments, contextual data may be used to provide understanding the user or entity associated with the data is a critical part of contextual information. This may encompass user profiles, demographics, preferences, historical interactions, and behavioral patterns. In some cases, contextual data may be specific to a particular domain or industry. For example, in healthcare, contextual data might include patient history, medical records, and diagnostic context. When extracting the contextual data, the AILCT™ controller 901 may be configured to place the user dataset through preprocessing steps to clean, transform, and organize the data for further analysis. This can include handling missing values, standardizing formats, and converting unstructured data (e.g., text) into structured representations. Based on the extracted background data, the AILCT™ controller 901 may identify and segregate attributes that contribute to the contextual understanding of the data. For instance, it can identify temporal attributes (timestamps), spatial attributes (location data), and other domain-specific contextual attributes. The processor can then engage in feature engineering, where it transforms the identified attributes into features suitable for analysis. This can involve creating new features, aggregating data, or deriving statistics to capture the context effectively.

The AILCT™ controller 901 may integrate external contextual data sources (e.g., weather data, user profiles, device information, and the like) to enrich the contextual understanding. This can involve querying APIs or accessing external databases. Utilizing the extracted metadata and engineered features, the processor may perform various analyses, such as statistical analysis, machine learning modeling, or data mining, to derive insights and predictions based on the context. The AILCT™ controller 901 can combine the insights obtained from the analysis with the identified contextual attributes and metadata to generate contextual data. This can involve creating structured representations that encapsulate both the original data and the derived insights in a way that is understandable and useful. For example, an AI model (e.g., supervisor 145) can be configured to receive contextual data 120 between 0 and 10,000 words. Some contextual data 120 may be configured to have between 100-3000 words.

In further accordance with the disclosure, the AILCT™ controller 901 can generate and/or update an AI model. As used in the current disclosure, an AI model is a machine-learning model that is configured to generate a query response or carry out any of the other functions described herein to support operation of the disclosed systems. Inputs to the AI model may include a user dataset, condition data, client preference data, user specific data, background data, contextual data, examples of query responses, and the like. Outputs of the AI model may include a query response tailored to the user dataset and the background data. AI model training data may include a plurality of data entries containing a plurality of inputs that are correlated to a plurality of outputs for training a processor by a machine-learning process. In an embodiment, AI model training data may include the user dataset and the background data as inputs correlated to examples of a query response. AI model training data may be received from a database. AI model training data may contain information about user dataset, condition data, client preference data, user specific data, background data, contextual data, examples of query responses, and the like. In an embodiment, AI model training data may be iteratively updated as a function of the input and output results of past AI models or any other machine-learning model mentioned throughout this disclosure. The machine-learning model may be performed using, without limitation, linear machine-learning models such as without limitation logistic regression and/or naive Bayes machine-learning models, nearest neighbor machine-learning models such as k-nearest neighbors machine-learning models, support vector machines, least squares support vector machines, fisher's linear discriminant, quadratic machine-learning models, decision trees, boosted trees, random forest machine-learning model, and the like.

In further accordance with the disclosure, the AILCT™ controller 901 can be configured to generate a AI model as a function of a user dataset and background data. The AI model can access and retrieve information from the internet or from pre-loaded databases as discussed elsewhere herein to answer user queries, provide recommendations, and offer informative responses and can be used to operate or enhance operation of the AILCT™ embodiments. The AI model can be integrated with the user dataset or other data as described herein so that the model has a deep understanding of the dataset's structure, metadata, and the types of data it contains. This understanding allows the model to provide accurate and relevant responses. The AI model may take into account the context of conversations, previous interactions, or any session-specific information to ensure coherence and relevance in responses. The model understands follow-up questions and maintains a contextually aware conversation when interacting with a human or automated user, such as another AI model.

An AI model in accordance with the present disclosure may be able to communicate with a user using a language processing model. This may include the ability to speak and understand and interpret human language, including context, intent, and sentiment. This enables the model to comprehend and respond to a wide range of user requests in a human-like way. Language processing model may include a program automatically generated by computing device and/or language processing module to produce associations between one or more words extracted from at least a document and detect associations, including without limitation mathematical associations, between such words. Associations between language elements, where language elements include for purposes herein extracted words, relationships of such categories to other such term may include, without limitation, mathematical associations, including without limitation statistical correlations between any language element and any other language element and/or language elements. Statistical correlations and/or mathematical associations may include probabilistic formulas or relationships indicating, for instance, a likelihood that a given extracted word indicates a given category of semantic meaning. As a further example, statistical correlations and/or mathematical associations may include probabilistic formulas or relationships indicating a positive and/or negative association between at least an extracted word and/or a given semantic meaning; positive or negative indication may include an indication that a given document is or is not indicating a category semantic meaning. Whether a phrase, sentence, word, or other textual element in a document or corpus of documents constitutes a positive or negative indicator may be determined, in an embodiment, by mathematical associations between detected words, comparisons to phrases and/or words indicating positive and/or negative indicators that are stored in memory at computing device, or the like.

The AILCT™ implementations may include a language processing module (e.g., 946) and/or diagnostic engine (e.g., 947) to generate the language processing model by any suitable method, including without limitation a natural language processing classification algorithm; language processing model may include a natural language process classification model that enumerates and/or derives statistical relationships between input terms and output terms. Algorithm to generate language processing model may include a stochastic gradient descent algorithm, which may include a method that iteratively optimizes an objective function, such as an objective function representing a statistical estimation of relationships between terms, including relationships between input terms and output terms, in the form of a sum of relationships to be estimated. In an alternative or additional approach, sequential tokens may be modeled as chains, serving as the observations in a Hidden Markov Model (HMM). HMMs has used herein are statistical models with inference algorithms that that may be applied to the models. In such models, a hidden state to be estimated may include an association between extracted words, phrases, and/or other semantic units. There may be a finite number of categories to which an extracted word may pertain; an HMM inference algorithm, such as the forward-backward algorithm or the Viterbi algorithm, may be used to estimate the most likely discrete state given a word or sequence of words Language processing module may combine two or more approaches. For instance, and without limitation, machine-learning program may use a combination of Naive-Bayes (NB), Stochastic Gradient Descent (SGD), and parameter grid-searching classification techniques; the result may include a classification algorithm that returns ranked associations.

The AILCT™ processor 901 may be configured to generate a vector space, which may be a collection of vectors, defined as a set of mathematical objects that can be added together under an operation of addition following properties of associativity, commutativity, existence of an identity element, and existence of an inverse element for each vector, and can be multiplied by scalar values under an operation of scalar multiplication compatible with field multiplication, and that has an identity element is distributive with respect to vector addition, and is distributive with respect to field addition. Each vector in an n-dimensional vector space may be represented by an n-tuple of numerical values. Each unique extracted word and/or language element as described above may be represented by a vector of the vector space. In an embodiment, each unique extracted and/or other language element may be represented by a dimension of vector space; as a non-limiting example, each element of a vector may include a number representing an enumeration of co-occurrences of the word and/or language element represented by the vector with another word and/or language element. Vectors may be normalized, scaled according to relative frequencies of appearance and/or file sizes. In an embodiment associating language elements to one another as described above may include computing a degree of vector similarity between a vector representing each language element and a vector representing another language element; vector similarity may be measured according to any norm for proximity and/or similarity of two vectors, including without limitation cosine similarity, which measures the similarity of two vectors by evaluating the cosine of the angle between the vectors, which can be computed using a dot product of the two vectors divided by the lengths of the two vectors. Degree of similarity may include any other geometric measure of distance between vectors.

The AILCT™ language processing module/NLP component 946 may use a corpus of documents to generate associations between language elements in a language processing module, and diagnostic engine may then use such associations to analyze words extracted from one or more documents and determine that the one or more documents indicate significance of a category. In embodiments, corpus documents may include any element of data disclosed herein, including user queries, user datasets, digital avatars, and the like. Corpus documents may additionally include questions and answers from a chatbot, worker input, or employer input. In an embodiment, component 946 may perform this analysis using a selected set of significant documents, such as documents identified by one or more experts as representing good information; experts may identify or enter such documents via graphical user interface, or may communicate identities of significant documents according to any other suitable method of electronic communication, or by providing such identity to other persons who may enter such identifications into apparatus 946. Documents may be entered into a computing device by being uploaded by an expert or other persons using, without limitation, file transfer protocol (FTP) or other suitable methods for transmission and/or upload of documents; alternatively or additionally, where a document is identified by a citation, a uniform resource identifier (URI), uniform resource locator (URL) or other datum permitting unambiguous identification of the document, diagnostic engine may automatically obtain the document using such an identifier, for instance by submitting a request to a database or compendium of documents such as JSTOR.

In further accordance with the disclosure, stored rules, modified images, and/or modifications to images may be entered and/or defined manually; alternatively or additionally, modified images, and/or modifications to images may be generated using a machine-learning process that may be trained using manually generated images, modifications thereto, and/or sequences of such images and/or modifications, and/or manually identified examples of such training examples in existing animated and/or live-action stills and/or sequences. Machine-learning models may include models trained to recognize features in a picture of a character, models trained to modify identified features and/or entire images, models trained to identify and/or generate transitional images traversing from one static image to another static image in a sequence, or the like. Static images and/or modifications may be associated with responses to particular inputs by additional models.

In further accordance with the disclosure, an AI model may include a large language model (LLM). A “large language model,” as used herein, is a deep learning algorithm that can recognize, summarize, translate, predict and/or generate text and other content based on knowledge gained from massive datasets. Large language model may be trained on large sets of data; for example, training sets may include greater than 1 million words. Training sets may be drawn from diverse sets of data such as, as non-limiting examples, novels, blog posts, articles, emails, user dataset, system data, databases of the AIELCT system, and the like. As a non-limiting example, training sets may include databases associated with an entity. In some embodiments, training sets may include portions of documents associated with the user business practices correlated to examples of a query responses.

Still referring to FIG. 1, LLM (e.g., 948) may include a transformer architecture. In some embodiments, an encoder component of LLM 948 may include transformer architecture. A “transformer architecture,” for the purposes of this disclosure is a neural network architecture that uses self-attention and positional encoding. Transformer architecture may be designed to process sequential input data, such as natural language, with applications towards tasks such as translation and text summarization. Transformer architecture may process the entire input all at once. “Positional encoding,” for the purposes of this disclosure, refers to a data processing technique that encodes the location or position of an entity in a sequence. In some embodiments, each position in the sequence may be assigned a unique representation. In some embodiments, positional encoding may include mapping each position in the sequence to a position vector. In some embodiments, trigonometric functions, such as sine and cosine, may be used to determine the values in the position vector. In some embodiments, position vectors for a plurality of positions in a sequence may be assembled into a position matrix, wherein each row of position matrix may represent a position in the sequence.

LLM 948 and/or transformer architecture may include an attention mechanism. An “attention mechanism,” as used herein, is a part of a neural architecture that enables a system to dynamically quantify the relevant features of the input data. In the case of natural language processing, input data may be a sequence of textual elements. It may be applied directly to the raw input or to its higher-level representation. Applying an attention mechanism, LLM 948 may predict the next word by searching for a set of position in a source sentence where the most relevant information is concentrated. LLM 948 may then predict the next word based on context vectors associated with these source positions and all the previous generated target words, such as textual data of a dictionary correlated to a prompt in a training data set. A “context vector,” as used herein, are fixed-length vector representations useful for document retrieval and word sense disambiguation.

The attention mechanism may include generalized attention self-attention, multi-head attention, additive attention, global attention, and the like. In generalized attention, when a sequence of words or an image is fed to LLM 948, it may verify each element of the input sequence and compare it against the output sequence. Each iteration may involve the mechanism's encoder capturing the input sequence and comparing it with each element of the decoder's sequence. From the comparison scores, the mechanism may then select the words or parts of the image that it needs to pay attention to. In self-attention, LLM 948 may pick up particular parts at different positions in the input sequence and over time compute an initial composition of the output sequence. In multi-head attention, LLM 948 may include a transformer model of an attention mechanism. Attention mechanisms, as described above, may provide context for any position in the input sequence. For example, if the input data is a natural language sentence, the transformer does not have to process one word at a time. In multi-head attention, computations by LLM 948 may be repeated over several iterations, each computation may form parallel layers known as attention heads. Each separate head may independently pass the input sequence and corresponding output sequence element through a separate head. A final attention score may be produced by combining attention scores at each head so that every nuance of the input sequence is taken into consideration. In additive attention (Bahdanau attention mechanism), LLM 948 may make use of attention alignment scores based on a number of factors. These alignment scores may be calculated at different points in a neural network. Source or input sequence words are correlated with target or output sequence words but not to an exact degree. This correlation may take into account all hidden states and the final alignment score is the summation of the matrix of alignment scores. In global attention (Luong mechanism), in situations where neural machine translations are required, LLM 948 may either attend to all source words or predict the target sentence, thereby attending to a smaller subset of words.

The transformer architecture may include a decoder. Decoder may a multi-headed attention layer, a pointwise feed-forward layer, one or more residual connections, and layer normalization (particularly after each sub-layer), as discussed in more detail above. In some embodiments, decoder may include two multi-headed attention layers. In some embodiments, decoder may be autoregressive. For the purposes of this disclosure, “autoregressive” means that the decoder takes in a list of previous outputs as inputs along with encoder outputs containing attention information from the input. Input to decoder may go through an embedding layer and positional encoding layer in order to obtain positional embeddings. Decoder may include a first multi-headed attention layer, wherein the first multi-headed attention layer may receive positional embeddings.

A first multi-headed attention layer may be configured to not condition to future tokens. As a non-limiting example, when computing attention scores on the word “am”, decoder should not have access to the word “fine” in “I am fine,” because that word is a future word that was generated after. The word “am” should only have access to itself and the words before it. In some embodiments, this may be accomplished by implementing a look-ahead mask. A look ahead mask is a matrix of the same dimensions as the scaled attention score matrix that is filled with “os” and negative infinities. For example, the top right triangle portion of look-ahead mask may be filed with negative infinities. Look-ahead mask may be added to scaled attention score matrix to obtain a masked score matrix. Masked score matrix may include scaled attention scores in the lower-left triangle of the matrix and negative infinities in the upper-right triangle of the matrix. Then, when the softmax of this matrix is taken, the negative infinities will be zeroed out; this leaves zero attention scores for “future tokens.”

A second multi-headed attention layer may use encoder outputs as queries and keys and the outputs from the first multi-headed attention layer as values. This process matches the encoder's input to the decoder's input, allowing the decoder to decide which encoder input is relevant to put a focus on. The output from second multi-headed attention layer may be fed through a pointwise feedforward layer for further processing. The output of the pointwise feedforward layer may be fed through a final linear layer. This final linear layer may act as a classifier. This classifier may be as big as the number of classes that you have. For example, if you have 10,000 classes for 10,000 words, the output of that classier will be of size 10,000. The output of this classifier may be fed into a softmax layer which may serve to produce probability scores between zero and one. The index may be taken of the highest probability score in order to determine a predicted word.

The decoder may take this output and add it to the decoder inputs. Decoder may continue decoding until a token is predicted. Decoder may stop decoding once it predicts an end token.

In some embodiments, the decoder (e.g., 949) may be stacked N layers high, with each layer taking in inputs from the encoder and layers before it. Stacking layers may allow LLM 948 to learn to extract and focus on different combinations of attention from its attention heads.

With continued reference to FIG. 1, LLM 948 may receive an input. Input may include a string of one or more characters. For example, input may include one or more words, a sentence, a paragraph, a thought, a query, and the like. A “query” for the purposes of the disclosure is a string of characters that poses a question. In some embodiments, input may be received from a user device. User device may be any computing device that is used by a user. As non-limiting examples, user device may include desktops, laptops, smartphones, tablets, and the like. Query may include, for example a question asking for a status update regarding a to-do list. In some embodiments, input may include a set of background data associated with the user dataset.

With continued reference to FIG. 1, LLM 948 may generate an output. In some embodiments, LLM 948 may include multiple sets of transformer architecture as described above. Output may include a textual output. A “textual output,” for the purposes of this disclosure is an output comprising a string of one or more characters. Textual output may include for example a comprehensive report. In some embodiments, textual output may include a phrase or sentence identifying the status of a user query. In some embodiments, textual output may include a sentence or plurality of sentences describing a response to a user query. As a non-limiting examples, this may include, restrictions, timing, advice, dangers, benefits, and the like.

Processor 901 may be configured to update the training data of the AI model using user inputs. AI model may use user input to update its training data, thereby improving its performance and accuracy. In embodiments, the AI model may be iteratively updated using input and output results of the AI model. The AI model may then be iteratively retrained using the updated machine-learning model. For instance, and without limitation, the AI model may be trained using first training data from, for example, and without limitation, training data from a user input or database. The AI model may then be updated by using previous inputs and outputs from the AI model as second training data to then train a second machine learning model. This process of updating the AI model may be continuously done to create subsequent AI models to improve the speed and accuracy of the AI model. When users interact with the software, their actions, preferences, and feedback provide valuable information that can be used to refine and enhance the model. This user input is collected and incorporated into the training data, allowing the machine learning model to learn from real-world interactions and adapt its predictions accordingly. By continually incorporating user input, the model becomes more responsive to user needs and preferences, capturing evolving trends and patterns. This iterative process of updating the training data with user input enables the machine learning model to deliver more personalized and relevant results, ultimately enhancing the overall user experience. The discussion within this paragraph may apply to both the AI model or any other machine-learning model. classifier discussed herein.

Incorporating the user feedback may include updating the training data by removing or adding correlations of user data to a path or resources as indicated by the feedback. Any machine-learning model as described herein may have the training data updated based on such feedback or data gathered using a web crawler as described above. For example, correlations in training data may be based on outdated information wherein, a web crawler may update such correlations based on more recent resources and information.

Processor 901 may use user feedback to train the machine-learning models and/or classifiers described above. For example, classifier may be trained using past inputs and outputs of classifier. In some embodiments, if user feedback indicates that an output of classifier was “bad,” then that output and the corresponding input may be removed from training data used to train classifier, and/or may be replaced with a value entered by, e.g., another value that represents an ideal output given the input the machine learning model originally received, permitting use in retraining, and adding to training data; in either case, classifier may be retrained with modified training data as described in further detail below. In some embodiments, training data of classifier may include user feedback.

Processor 901 may implement one or more aspects of “generative artificial intelligence (AI),” a type of AI that uses machine learning algorithms to create, establish, or otherwise generate data such as, without limitation, user score or comprehensive report and/or the like in any data structure as described herein (e.g., text, image, video, audio, among others) that is similar to one or more provided training examples. In an embodiment, machine learning module described herein may generate one or more generative machine learning models that are trained on one or more set of event training data and/or report training data. One or more generative machine learning models may be configured to generate new examples that are similar to the training data of the one or more generative machine learning models but are not exact replicas; for instance, and without limitation, data quality or attributes of the generated examples may bear a resemblance to the training data provided to one or more generative machine learning models, wherein the resemblance may pertain to underlying patterns, features, or structures found within the provided training data.

In some cases, generative machine learning models may include one or more generative models. As described herein, “generative models” refers to statistical models of the joint probability distribution P (X, Y) on a given observable variable x, representing features or data that can be directly measured or observed (e.g user dataset and contextual data) and target variable y, representing the outcomes or labels that one or more generative models aims to predict or generate (e.g., a AI model). In some cases, generative models may rely on Bayes theorem to find joint probability; for instance, and without limitation, Naïve Bayes classifiers may be employed by processor to categorize input data such as, without limitation the contextual data and the user data set into different one or more query responses.

One or more generative machine learning models may include one or more Naïve Bayes classifiers generated, by processor, using a Naïve bayes classification algorithm. Naïve Bayes classification algorithm generates classifiers by assigning class labels to problem instances, represented as vectors of element values. Class labels are drawn from a finite set. Naïve Bayes classification algorithm may include generating a family of algorithms that assume that the value of a particular element is independent of the value of any other element, given a class variable. Naïve Bayes classification algorithm may be based on Bayes. A naïve Bayes algorithm may be generated by first transforming training data into a frequency table. Processor 901 may then calculate a likelihood table by calculating probabilities of different data entries and classification labels. Processor 901 may utilize a naïve Bayes equation to calculate a posterior probability for each class. A class containing the highest posterior probability is the outcome of prediction.

In some embodiments, one or more generative machine learning models may include generative adversarial network (GAN). As used in this disclosure, a “generative adversarial network” is a type of artificial neural network with at least two sub models (e.g., neural networks), a generator, and a discriminator, that compete against each other in a process that ultimately results in the generator learning to generate new data samples, wherein the “generator” is a component of the GAN that learns to create hypothetical data by incorporating feedbacks from the “discriminator” configured to distinguish real data from the hypothetical data. In some cases, generator may learn to make discriminator classify its output as real. In an embodiment, discriminator may include a supervised machine learning model while generator may include an unsupervised machine learning model.

An AI model as set forth herein may be implemented as a fuzzy inferencing system to generate a query response or make a different determination. As used in the current disclosure, a “fuzzy inference” is a method that interprets the values in the input vector and, based on a set of rules, assigns values to the output vector. A set of fuzzy rules may include a collection of linguistic variables that describe how the system should make a decision regarding classifying an input or controlling an output.

The processor 901 may embed a AI model with one or more security identifiers. As used in the current disclosure, a “security identifier” is an identifier that is configured to be unique to the specific AI model. A security identifier may be configured to identify the specific AI model from a number of AI models. A security identifier may include a unique piece of information or a token that authenticates the AI model and authorizes users to interact with the AI model. A security identifier may serve as a digital fingerprint to the AI model. In a non-limiting example, the security identifier may contain various information about the creation training, place of origin, various attributes, and the like associated with the AI model. Alternatively, a security identifier may be used to regulate access to a AI model. In some cases, a user may be required to posses a knowledge factor in order to access the AI model, wherein a knowledge factor may include knowledge of a code. A security identifier may play a crucial role in ensuring that only authorized individuals or systems can access and use the AI model, thus enhancing the security and privacy of the interactions. In an embodiment, a security identifier may be a distinctive piece of data, such as an alphanumeric code, that serves as a unique identifier for each user or system. The security identifier may be used as part of the authentication process. When a user interacts with the AI model, they may be required to provide this identifier to verify their identity and access rights. The security identifier can be in the form of a token, such as an API key, authentication token, or a unique session identifier. These tokens are issued during the authentication process and are used to access the AI model securely. In some cases the security identifier may be a part of a multi-factor authentication system, where users need to provide additional verification methods, such as a password or biometrics, along with the security identifier, to access the AI model.

An exemplary embodiment of a machine-learning component 950 or module that may perform one or more machine-learning processes as described in this disclosure is illustrated. Machine-learning module may perform determinations, classification, and/or analysis steps, methods, processes, or the like as described in this disclosure using machine learning processes. A “machine learning process,” as used in this disclosure, is a process that automatedly uses training data to generate an algorithm instantiated in hardware or software logic, data structures, and/or functions that will be performed by a computing device/module to produce outputs given data provided as inputs; this is in contrast to a non-machine learning software program where the commands to be executed are determined in advance by a user and written in a programming language.

“Training data,” as used herein, is data containing correlations that a machine-learning process may use to model relationships between two or more categories of data elements. For instance, and without limitation, training data may include a plurality of data entries, also known as “training examples,” each entry representing a set of data elements that were recorded, received, and/or generated together; data elements may be correlated by shared existence in a given data entry, by proximity in a given data entry, or the like. Multiple data entries in training data may evince one or more trends in correlations between categories of data elements; for instance, and without limitation, a higher value of a first data element belonging to a first category of data element may tend to correlate to a higher value of a second data element belonging to a second category of data element, indicating a possible proportional or other mathematical relationship linking values belonging to the two categories. Multiple categories of data elements may be related in training data according to various correlations; correlations may indicate causative and/or predictive links between categories of data elements, which may be modeled as relationships such as mathematical relationships by machine-learning processes as described in further detail below. Training data may be formatted and/or organized by categories of data elements, for instance by associating data elements with one or more descriptors corresponding to categories of data elements. As a non-limiting example, training data may include data entered in standardized forms by persons or processes, such that entry of a given data element in a given field in a form may be mapped to one or more descriptors of categories. Elements in training data may be linked to descriptors of categories by tags, tokens, or other data elements; for instance, and without limitation, training data may be provided in fixed-length formats, formats linking positions of data to categories such as comma-separated value (CSV) formats and/or self-describing formats such as extensible markup language (XML), JavaScript Object Notation (JSON), or the like, enabling processes or devices to detect categories of data.

Training examples for use as training data may be selected from a population of potential examples according to cohorts relevant to an analytical problem to be solved, a classification task, or the like. Alternatively or additionally, training data may be selected to span a set of likely circumstances or inputs for a machine-learning model and/or process to encounter when deployed. For instance, and without limitation, for each category of input data to a machine-learning process or model that may exist in a range of values in a population of phenomena such as images, user data, process data, physical data, or the like, a computing device, processor, and/or machine-learning model may select training examples representing each possible value on such a range and/or a representative sample of values on such a range. Selection of a representative sample may include selection of training examples in proportions matching a statistically determined and/or predicted distribution of such values according to relative frequency, such that, for instance, values encountered more frequently in a population of data so analyzed are represented by more training examples than values that are encountered less frequently. Alternatively or additionally, a set of training examples may be compared to a collection of representative values in a database and/or presented to a user, so that a process can detect, automatically or via user input, one or more values that are not included in the set of training examples. Computing device, processor, and/or module may automatically generate a missing training example; this may be done by receiving and/or retrieving a missing input and/or output value and correlating the missing input and/or output value with a corresponding output and/or input value collocated in a data record with the retrieved value, provided by a user and/or other device, or the like.

The disclosed embodiments may be further configured to sanitize training data. “Sanitizing” training data, as used in this disclosure, is a process whereby training examples are removed that interfere with convergence of a machine-learning model and/or process to a useful result. For instance, and without limitation, a training example may include an input and/or output value that is an outlier from typically encountered values, such that a machine-learning algorithm using the training example will be adapted to an unlikely amount as an input and/or output; a value that is more than a threshold number of standard deviations away from an average, mean, or expected value, for instance, may be eliminated. Alternatively or additionally, one or more training examples may identified as having poor quality data, where “poor quality” is defined as having a signal to noise ratio below a threshold value.

For example, images used to train an image classifier or other machine-learning model and/or process that takes images as inputs or generates images as outputs may be rejected if image quality is below a threshold value. For instance, and without limitation, computing device, processor, and/or module may perform blur detection, and eliminate one or more Blur detection may be performed, as a non-limiting example, by taking Fourier transform, or an approximation such as a Fast Fourier Transform (FFT) of the image and analyzing a distribution of low and high frequencies in the resulting frequency-domain depiction of the image; numbers of high-frequency values below a threshold level may indicate blurriness. As a further non-limiting example, detection of blurriness may be performed by convolving an image, a channel of an image, or the like with a Laplacian kernel; this may generate a numerical score reflecting a number of rapid changes in intensity shown in the image, such that a high score indicates clarity, and a low score indicates blurriness. Blurriness detection may be performed using a gradient-based operator, which measures operators based on the gradient or first derivative of an image, based on the hypothesis that rapid changes indicate sharp edges in the image, and thus are indicative of a lower degree of blurriness. Blur detection may be performed using Wavelet-based operator, which takes advantage of the capability of coefficients of the discrete wavelet transform to describe the frequency and spatial content of images. Blur detection may be performed using statistics-based operators take advantage of several image statistics as texture descriptors in order to compute a focus level. Blur detection may be performed by using discrete cosine transform (DCT) coefficients in order to compute a focus level of an image from its frequency content.

The disclosed embodiments may be configured to precondition one or more training examples. For instance, and without limitation, where a machine learning model and/or process has one or more inputs and/or outputs requiring, transmitting, or receiving a certain number of bits, samples, or other units of data, one or more training examples' elements to be used as or compared to inputs and/or outputs may be modified to have such a number of units of data. For instance, a computing device, processor, and/or module may convert a smaller number of units, such as in a low pixel count image, into a desired number of units, for instance by upsampling and interpolating. As a non-limiting example, a low pixel count image may have 100 pixels, however a desired number of pixels may be 128. Processor may interpolate the low pixel count image to convert the 100 pixels into 128 pixels. It should also be noted that one of ordinary skill in the art, upon reading this disclosure, would know the various methods to interpolate a smaller number of data units such as samples, pixels, bits, or the like to a desired number of such units. In some instances, a set of interpolation rules may be trained by sets of highly detailed inputs and/or outputs and corresponding inputs and/or outputs downsampled to smaller numbers of units, and a neural network or other machine learning model that is trained to predict interpolated pixel values using the training data. As a non-limiting example, a sample input and/or output, such as a sample picture, with sample-expanded data units (e.g., pixels added between the original pixels) may be input to a neural network or machine-learning model and output a pseudo replica sample-picture with dummy values assigned to pixels between the original pixels based on a set of interpolation rules. As a non-limiting example, in the context of an image classifier, a machine-learning model may have a set of interpolation rules trained by sets of highly detailed images and images that have been downsampled to smaller numbers of pixels, and a neural network or other machine learning model that is trained using those examples to predict interpolated pixel values in a facial picture context. As a result, an input with sample-expanded data units (the ones added between the original data units, with dummy values) may be run through a trained neural network and/or model, which may fill in values to replace the dummy values. Alternatively or additionally, processor, computing device, and/or module may utilize sample expander methods, a low-pass filter, or both. As used in this disclosure, a “low-pass filter” is a filter that passes signals with a frequency lower than a selected cutoff frequency and attenuates signals with frequencies higher than the cutoff frequency. The exact frequency response of the filter depends on the filter design. Computing device, processor, and/or module may use averaging, such as luma or chroma averaging in images, to fill in data units in between original data units

The disclosed embodiments may down-sample elements of a training example to a desired lower number of data elements. As a non-limiting example, a high pixel count image may have 256 pixels, however a desired number of pixels may be 128. Processor may down-sample the high pixel count image to convert the 256 pixels into 128 pixels. In some embodiments, processor may be configured to perform downsampling on data. Downsampling, also known as decimation, may include removing every Nth entry in a sequence of samples, all but every Nth entry, or the like, which is a process known as “compression,” and may be performed, for instance by an N-sample compressor implemented using hardware or software. Anti-aliasing and/or anti-imaging filters, and/or low-pass filters, may be used to clean up side-effects of compression.

The machine-learning component 950 may be configured to perform a lazy-learning process and/or protocol, which may alternatively be referred to as a “lazy loading” or “call-when-needed” process and/or protocol, may be a process whereby machine learning is conducted upon receipt of an input to be converted to an output, by combining the input and training set to derive the algorithm to be used to produce the output on demand. For instance, an initial set of simulations may be performed to cover an initial heuristic and/or “first guess” at an output and/or relationship. As a non-limiting example, an initial heuristic may include a ranking of associations between inputs and elements of training data. Heuristic may include selecting some number of highest-ranking associations and/or training data elements. Lazy learning may implement any suitable lazy learning algorithm, including without limitation a K-nearest neighbors algorithm, a lazy naïve Bayes algorithm, or the like; persons skilled in the art, upon reviewing the entirety of this disclosure, will be aware of various lazy-learning algorithms that may be applied to generate outputs as described in this disclosure, including without limitation lazy learning applications of machine-learning algorithms as described in further detail below.

Machine-learning processes as described in this disclosure may be used to generate machine-learning models. A “machine-learning model,” as used in this disclosure, is a data structure representing and/or instantiating a mathematical and/or algorithmic representation of a relationship between inputs and outputs, as generated using any machine-learning process including without limitation any process as described above, and stored in memory; an input is submitted to a machine-learning model once created, which generates an output based on the relationship that was derived. For instance, and without limitation, a linear regression model, generated using a linear regression algorithm, may compute a linear combination of input data using coefficients derived during machine-learning processes to calculate an output datum. As a further non-limiting example, a machine-learning model may be generated by creating an artificial neural network, such as a convolutional neural network comprising an input layer of nodes, one or more intermediate layers, and an output layer of nodes. Connections between nodes may be created via the process of “training” the network, in which elements from a training data set are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

Machine-learning algorithms may include at least a supervised machine-learning process. At least a supervised machine-learning process, as defined herein, include algorithms that receive a training set relating a number of inputs to a number of outputs, and seek to generate one or more data structures representing and/or instantiating one or more mathematical relations relating inputs to outputs, where each of the one or more mathematical relations is optimal according to some criterion specified to the algorithm using some scoring function. For instance, a supervised learning algorithm may include condition data as described above as inputs, target specific data as outputs, and a scoring function representing a desired form of relationship to be detected between inputs and outputs; scoring function may, for instance, seek to maximize the probability that a given input and/or combination of elements inputs is associated with a given output to minimize the probability that a given input is not associated with a given output. Scoring function may be expressed as a risk function representing an “expected loss” of an algorithm relating inputs to outputs, where loss is computed as an error function representing a degree to which a prediction generated by the relation is incorrect when compared to a given input-output pair provided in training data.

Training a supervised machine-learning process may include, without limitation, iteratively updating coefficients, biases, weights based on an error function, expected loss, and/or risk function. For instance, an output generated by a supervised machine-learning model using an input example in a training example may be compared to an output example from the training example; an error function may be generated based on the comparison, which may include any error function suitable for use with any machine-learning algorithm described in this disclosure, including a square of a difference between one or more sets of compared values or the like. Such an error function may be used in turn to update one or more weights, biases, coefficients, or other parameters of a machine-learning model through any suitable process including without limitation gradient descent processes, least-squares processes, and/or other processes described in this disclosure. This may be done iteratively and/or recursively to gradually tune such weights, biases, coefficients, or other parameters. Updating may be performed, in neural networks, using one or more back-propagation algorithms. Iterative and/or recursive updates to weights, biases, coefficients, or other parameters as described above may be performed until currently available training data is exhausted and/or until a convergence test is passed, where a “convergence test” is a test for a condition selected as indicating that a model and/or weights, biases, coefficients, or other parameters thereof has reached a degree of accuracy. A convergence test may, for instance, compare a difference between two or more successive errors or error function values, where differences below a threshold amount may be taken to indicate convergence. Alternatively or additionally, one or more errors and/or error function values evaluated in training iterations may be compared to a threshold.

The disclosed machine learning processes may include an unsupervised machine-learning processes. An unsupervised machine-learning process, as used herein, is a process that derives inferences in datasets without regard to labels; as a result, an unsupervised machine-learning process may be free to discover any structure, relationship, and/or correlation provided in the data. Unsupervised processes may not require a response variable; unsupervised processes may be used to find interesting patterns and/or inferences between variables, to determine a degree of correlation between two or more variables, or the like.

Machine-learning component 950 may be designed and configured to create a machine-learning model using techniques for development of linear regression models. Linear regression models may include ordinary least squares regression, which aims to minimize the square of the difference between predicted outcomes and actual outcomes according to an appropriate norm for measuring such a difference (e.g. a vector-space distance norm); coefficients of the resulting linear equation may be modified to improve minimization. Linear regression models may include ridge regression methods, where the function to be minimized includes the least-squares function plus term multiplying the square of each coefficient by a scalar amount to penalize large coefficients. Linear regression models may include least absolute shrinkage and selection operator (LASSO) models, in which ridge regression is combined with multiplying the least-squares term by a factor of 1 divided by double the number of samples. Linear regression models may include a multi-task lasso model wherein the norm applied in the least-squares term of the lasso model is the Frobenius norm amounting to the square root of the sum of squares of all terms. Linear regression models may include the elastic net model, a multi-task elastic net model, a least angle regression model, a LARS lasso model, an orthogonal matching pursuit model, a Bayesian regression model, a logistic regression model, a stochastic gradient descent model, a perceptron model, a passive aggressive algorithm, a robustness regression model, a Huber regression model, or any other suitable model that may occur to persons skilled in the art upon reviewing the entirety of this disclosure. Linear regression models may be generalized in an embodiment to polynomial regression models, whereby a polynomial equation (e.g. a quadratic, cubic or higher-order equation) providing a best predicted output/actual output fit is sought; similar methods to those described above may be applied to minimize error functions, as will be apparent to persons skilled in the art upon reviewing the entirety of this disclosure.

Machine-learning algorithms may include, without limitation, linear discriminant analysis. Machine-learning algorithm may include quadratic discriminant analysis. Machine-learning algorithms may include kernel ridge regression. Machine-learning algorithms may include support vector machines, including without limitation support vector classification-based regression processes. Machine-learning algorithms may include stochastic gradient descent algorithms, including classification and regression algorithms based on stochastic gradient descent. Machine-learning algorithms may include nearest neighbors algorithms. Machine-learning algorithms may include various forms of latent space regularization such as variational regularization. Machine-learning algorithms may include Gaussian processes such as Gaussian Process Regression. Machine-learning algorithms may include cross-decomposition algorithms, including partial least squares and/or canonical correlation analysis. Machine-learning algorithms may include naïve Bayes methods. Machine-learning algorithms may include algorithms based on decision trees, such as decision tree classification or regression algorithms. Machine-learning algorithms may include ensemble methods such as bagging meta-estimator, forest of randomized trees, AdaBoost, gradient tree boosting, and/or voting classifier methods. Machine-learning algorithms may include neural net algorithms, including convolutional neural net processes.

A machine-learning model and/or process may be deployed or instantiated by incorporation into a program, apparatus, system and/or module. For instance, and without limitation, a machine-learning model, neural network, and/or some or all parameters thereof may be stored and/or deployed in any memory or circuitry. Parameters such as coefficients, weights, and/or biases may be stored as circuit-based constants, such as arrays of wires and/or binary inputs and/or outputs set at logic “1” and “0” voltage levels in a logic circuit to represent a number according to any suitable encoding system including twos complement or the like or may be stored in any volatile and/or non-volatile memory. Similarly, mathematical operations and input and/or output of data to or from models, neural network layers, or the like may be instantiated in hardware circuitry and/or in the form of instructions in firmware, machine-code such as binary operation code instructions, assembly language, or any higher-order programming language. Any technology for hardware and/or software instantiation of memory, instructions, data structures, and/or algorithms may be used to instantiate a machine-learning process and/or model, including without limitation any combination of production and/or configuration of non-reconfigurable hardware elements, circuits, and/or modules such as without limitation ASICs, production and/or configuration of reconfigurable hardware elements, circuits, and/or modules such as without limitation

FPGAS, production and/or of non-reconfigurable and/or configuration non-rewritable memory elements, circuits, and/or modules such as without limitation non-rewritable ROM, production and/or configuration of reconfigurable and/or rewritable memory elements, circuits, and/or modules such as without limitation rewritable ROM or other memory technology described in this disclosure, and/or production and/or configuration of any computing device and/or component thereof as described in this disclosure. Such deployed and/or instantiated machine-learning model and/or algorithm may receive inputs from any other process, module, and/or component described in this disclosure, and produce outputs to any other process, module, and/or component described in this disclosure.

Any process of training, retraining, deployment, and/or instantiation of any machine-learning model and/or algorithm may be performed and/or repeated after an initial deployment and/or instantiation to correct, refine, and/or improve the machine-learning model and/or algorithm. Such retraining, deployment, and/or instantiation may be performed as a periodic or regular process, such as retraining, deployment, and/or instantiation at regular elapsed time periods, after some measure of volume such as a number of bytes or other measures of data processed, a number of uses or performances of processes described in this disclosure, or the like, and/or according to a software, firmware, or other update schedule. Alternatively or additionally, retraining, deployment, and/or instantiation may be event-based, and may be triggered, without limitation, by user inputs indicating sub-optimal or otherwise problematic performance and/or by automated field testing and/or auditing processes, which may compare outputs of machine-learning models and/or algorithms, and/or errors and/or error functions thereof, to any thresholds, convergence tests, or the like, and/or may compare outputs of processes described herein to similar thresholds, convergence tests or the like. Event-based retraining, deployment, and/or instantiation may alternatively or additionally be triggered by receipt and/or generation of one or more new training examples; a number of new training examples may be compared to a preconfigured threshold, where exceeding the preconfigured threshold may trigger retraining, deployment, and/or instantiation.

Retraining and/or additional training may be performed using any process for training described above, using any currently or previously deployed version of a machine-learning model and/or algorithm as a starting point. Training data for retraining may be collected, preconditioned, sorted, classified, sanitized, or otherwise processed according to any process described in this disclosure. Training data may include, without limitation, training examples including inputs and correlated outputs used, received, and/or generated from any version of any system, module, machine-learning model or algorithm, apparatus, and/or method described in this disclosure; such examples may be modified and/or labeled according to user feedback or other processes to indicate desired results, and/or may have actual or measured results from a process being modeled and/or predicted by system, module, machine-learning model or algorithm, apparatus, and/or method as “desired” results to be compared to outputs for training processes as described above.

Redeployment may be performed using any reconfiguring and/or rewriting of reconfigurable and/or rewritable circuit and/or memory elements; alternatively, redeployment may be performed by production of new hardware and/or software components, circuits, instructions, or the like, which may be added to and/or may replace existing hardware and/or software components, circuits, instructions, or the like.

An immutable sequential listing is illustrated. An “immutable sequential listing,” as used in this disclosure, is a data structure that places data entries in a fixed sequential arrangement, such as a temporal sequence of entries and/or blocks thereof, where the sequential arrangement, once established, cannot be altered, or reordered. An immutable sequential listing may be, include and/or implement an immutable ledger, where data entries that have been posted to the immutable sequential listing cannot be altered. Data elements are listing in immutable sequential listing; data elements may include any form of data, including textual data, image data, encrypted data, cryptographically hashed data, and the like. Data elements may include, without limitation, one or more at least a digitally signed assertions. In one embodiment, a digitally signed assertion is a collection of textual data signed using a secure proof as described in further detail below; secure proof may include, without limitation, a digital signature as described above. Collection of textual data may contain any textual data, including without limitation American Standard Code for Information Interchange (ASCII), Unicode, or similar computer-encoded textual data, any alphanumeric data, punctuation, diacritical mark, or any character or other marking used in any writing system to convey information, in any form, including any plaintext or cyphertext data; in an embodiment, collection of textual data may be encrypted, or may be a hash of other data, such as a root or node of a Merkle tree or hash tree, or a hash of any other information desired to be recorded in some fashion using a digitally signed assertion. In an embodiment, collection of textual data states that the owner of a certain transferable item represented in a digitally signed assertion register is transferring that item to the owner of an address. A digitally signed assertion may be signed by a digital signature created using the private key associated with the owner's public key, as described above.

A digitally signed assertion 304 may describe a transfer of virtual currency, such as crypto-currency. The virtual currency may be a digital currency. Item of value may be a transfer of trust, for instance represented by a statement vouching for the identity or trustworthiness of the first entity. Item of value may be an interest in a fungible negotiable financial instrument representing ownership in a public or private corporation, a creditor relationship with a governmental body or a corporation, rights to ownership represented by an option, derivative financial instrument, commodity, debt-backed security such as a bond or debenture or other security as described in further detail below. A resource may be a physical machine e.g. a ride share vehicle or any other asset. A digitally signed assertion may describe the transfer of a physical good; for instance, a digitally signed assertion may describe the sale of a product. In some embodiments, a transfer nominally of one item may be used to represent a transfer of another item; for instance, a transfer of virtual currency may be interpreted as representing a transfer of an access right; conversely, where the item nominally transferred is something other than virtual currency, the transfer itself may still be treated as a transfer of virtual currency, having value that depends on many potential factors including the value of the item nominally transferred and the monetary value attendant to having the output of the transfer moved into a particular user's control. The item of value may be associated with a digitally signed assertion by means of an exterior protocol, such as the COLORED COINS created according to protocols developed by The Colored Coins Foundation, the MASTERCOIN protocol developed by the Mastercoin Foundation, or the ETHEREUM platform offered by the Stiftung Ethereum Foundation of Baar, Switzerland, the Thunder protocol developed by Thunder Consensus, or any other protocol.

In some embodiments, an address is a textual datum identifying the recipient of virtual currency or another item of value in a digitally signed assertion. In some embodiments, address is linked to a public key, the corresponding private key of which is owned by the recipient of a digitally signed assertion. For instance, address may be the public key. Address may be a representation, such as a hash, of the public key. Address may be linked to the public key in memory of a computing device, for instance via a “wallet shortener” protocol. Where address is linked to a public key, a transferee in a digitally signed assertion may record a subsequent a digitally signed assertion transferring some or all of the value transferred in the first a digitally signed assertion to a new address in the same manner. A digitally signed assertion may contain textual information that is not a transfer of some item of value in addition to, or as an alternative to, such a transfer. For instance, as described in further detail below, a digitally signed assertion may indicate a confidence level associated with a distributed storage node as described in further detail below.

In some embodiments, immutable sequential listing, once formed, may be inalterable by any party, no matter what access rights that party possesses. For instance, immutable sequential listing may include a hash chain, in which data is added during a successive hashing process to ensure non-repudiation. Immutable sequential listing may include a block chain. In one embodiment, a block chain is immutable sequential listing that records one or more new at least a posted content in a data item known as a sub-listing or “block.” An example of a block chain is the BITCOIN block chain used to record BITCOIN transactions and values. Sub-listings may be created in a way that places the sub-listings in chronological order and link each sub-listing to a previous sub-listing in the chronological order so that any computing device may traverse the sub-listings in reverse chronological order to verify any at least a posted content listed in the block chain. Each new sub-listing may be required to contain a cryptographic hash describing the previous sub-listing. In some embodiments, the block chain contains a single first sub-listing sometimes known as a “genesis block.”

### Networks

Networks are commonly thought to comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The AILCT™ controller 901 may be based on computer systems that may comprise, but are not limited to, components such as: a computer systemization 902 connected to memory 929.

### Computer Systemization

A computer systemization 902 may comprise a clock 930, central processing unit (“CPU(s)” and/or “processor(s)” (these terms are used interchangeable throughout the disclosure unless noted to the contrary)) 903, a memory 929 (e.g., a read only memory (ROM) 906, a random access memory (RAM) 905, etc.), and/or an interface bus 907, and most frequently, although not necessarily, are all interconnected and/or communicating through a system bus 904 on one or more (mother) board(s) 902 having conductive and/or otherwise transportive circuit pathways through which instructions (e.g., binary encoded signals) may travel to effectuate communications, operations, storage, etc. The computer systemization may be connected to a power source 986; e.g., optionally the power source may be internal. Optionally, a cryptographic processor 926, LLM chips 926a and/or transceivers (e.g., ICs) 974 may be connected to the system bus. In another embodiment, the cryptographic processor and/or transceivers may be connected as either internal and/or external peripheral devices 912 via the interface bus I/O.

Depending on the particular implementation, features of the AILCT™ embodiments may be achieved by implementing a microcontroller such as CAST's R8051XC2 microcontroller; Intel's MCS 51 (i.e., 8051 microcontroller); NVIDIA LLM processors and/or the like. Also, to implement certain features of the AILCT™ embodiments, some feature implementations may rely on embedded components, such as: Application-Specific Integrated Circuit (“ASIC”), Digital Signal Processing (“DSP”), Field Programmable Gate Array (“FPGA”), and/or the like embedded technology. For example, any of the AILCT™ embodiments component collection (distributed or otherwise) and/or features may be implemented via the microprocessor and/or via embedded components; e.g., via ASIC, coprocessor, DSP, FPGA, and/or the like. Alternately, some implementations of the AILCT™ embodiments may be implemented with embedded components that are configured and used to achieve a variety of features or signal processing.

### Power Source

The power source 986 may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell 986 is connected to at least one of the interconnected subsequent components of the AILCT™ embodiments thereby providing an electric current to all subsequent components. In one example, the power source 986 is connected to the system bus component 904. In an alternative embodiment, an outside power source 986 is provided through a connection across the I/O 908 interface. For example, a USB and/or IEEE 1394 connection carries both data and power across the connection and is therefore a suitable source of power.

### Interface Adapters

Interface bus(ses) 907 may accept, connect, and/or communicate to a number of interface adapters, conventionally although not necessarily in the form of adapter cards, such as but not limited to: input output interfaces (I/O) 908, storage interfaces 909, network interfaces 910, and/or the like. Optionally, cryptographic processor interfaces 927 similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E) ISA), Micro Channel Architecture (MCA), NuBus, Peripheral Component Interconnect (Extended) (PCI (X)), PCI Express, Personal Computer Memory Card International Association (PCMCIA), and/or the like.

It should be noted that although user input devices and peripheral devices may be employed, the AILCT™ controller may be embodied as an embedded, dedicated, and/or monitor-less (i.e., headless) device, wherein access would be provided over a network interface connection.

### Memory

Generally, any mechanization and/or embodiment allowing a processor to affect the storage and/or retrieval of information is regarded as memory 929. However, memory is a fungible technology and resource, thus, any number of memory embodiments may be employed in lieu of or in concert with one another. It is to be understood that the AILCT™ controller and/or a computer systemization may employ various forms of memory 929. For example, a computer systemization may be configured wherein the operation of on-chip CPU memory (e.g., registers), RAM, ROM, and any other storage devices.

Together and/or separately system memory and one or more storage devices can be referred to as memory (e.g., physical memory). Memory contains processor-operable (e.g., accessible) data stores. Data stores include data that may be used via the disclosed system. Such data may be organized using one or more data formats such as one or more of a database (e.g., a relational database with database tables, an object-oriented database, a graph database, a hierarchical database), a flat file (e.g., organized into a tabular format), a binary file (e.g., a GIF file, an MPEG-4 file), a structured file (e.g., an HTML file, an XML file), a text file, and/or the like. Furthermore, data may be organized using one or more data structures such as an array, a queue, a stack, a set, a linked list, a map, a tree, a hash, a record, an object, a directed graph, and/or the like. In various embodiments, data stores may be organized in any number of ways (e.g., using any number and configuration of data formats, data structures, coordinator elements, and/or the like) to facilitate operation. For example, data stores can comprise data stores implemented as one or more (e.g., graph) databases or databases of vectorized data to function as maps facilitate AI model training and AI model operation.

### Component Collection

The memory 929 may contain a collection of program and/or database components and/or data such as, but not limited to: operating system component(s) 915 (operating system); information server component(s) 916 (information server); user interface component(s) 917 (user interface); Web browser component(s) 918 (Web browser); database(s) 919; mail server component(s) 921; mail client component(s) 922; cryptographic server component(s) 920 (cryptographic server); the AILCT™ embodiments component(s) 935; and/or the like (i.e., collectively a component collection). These components may be stored and accessed from the storage devices and/or from storage devices accessible through an interface bus. Although non-conventional program components such as those in the component collection, typically, are stored in a local storage device 914, they may also be loaded and/or stored in memory such as: peripheral devices, RAM, remote storage facilities through a communications network, ROM, various forms of memory, and/or the like.

### Operating System

The operating system component 915 is an executable program component facilitating the operation of the AILCT™ controller. Typically, the operating system facilitates access of I/O, network interfaces, peripheral devices, storage devices, and/or the like. The operating system may be a highly fault tolerant, scalable, and secure system such as: Apple Macintosh OS X (Server); AT&T Plan 9; Be OS; Unix and Unix-like system distributions (such as AT&T's UNIX; Berkley Software Distribution (BSD) variations such as FreeBSD, NetBSD, OpenBSD, and/or the like; Linux distributions such as Red Hat, Ubuntu, and/or the like); and/or the like operating systems.

### Information Server

An information server component 916 is a stored program component that is executed by a CPU. The information server may be a conventional Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective-) C (++), C# and/or .NET.

Access to the AILCT™ database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the AILCT™ embodiments. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the AILCT™ embodiments as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

### User Interface

Computer interfaces in some respects are similar to automobile operation interfaces. Automobile operation interface elements such as steering wheels, gearshifts, and speedometers facilitate the access, operation, and display of automobile resources, and status. Computer interaction interface elements such as check boxes, cursors, menus, scrollers, and windows (collectively and commonly referred to as widgets) similarly facilitate the access, capabilities, operation, and display of data and computer hardware and operating system resources, and status. Operation interfaces are commonly called user interfaces. Graphical user interfaces (GUIs) such as the Apple Macintosh Operating System's Aqua, IBM's OS/2, Microsoft's Windows 2000/2003/3.1/95/98/CE/Millenium/NT/XP/Vista/7 (i.e., Aero), Unix's X-Windows (e.g., which may include additional Unix graphic interface libraries and layers such as K Desktop Environment (KDE), mythTV and GNU Network Object Model Environment (GNOME)), web interface libraries (e.g., ActiveX, AJAX, (D) HTML, FLASH, Java, JavaScript, etc. interface libraries such as, but not limited to, Dojo, jQuery (UI), MooTools, Prototype, script.aculo.us, SWFObject, Yahoo! User Interface, any of which may be used and) provide a baseline and means of accessing and displaying information graphically to users.

A user interface component 917 is a stored program component that is executed by a CPU. The user interface may be a conventional graphic user interface as provided by, with, and/or atop operating systems and/or operating environments such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

### Web Browser

A Web browser component 918 is a stored program component that is executed by a CPU. The Web browser may be a conventional hypertext viewing application such as Microsoft Internet Explorer or Netscape Navigator. Secure Web browsing may be supplied with 128 bit (or greater) encryption by way of HTTPS, SSL, and/or the like. Web browsers allowing for the execution of program components through facilities such as ActiveX, AJAX, (D) HTML, FLASH, Java, JavaScript, web browser plug-in APIs (e.g., FireFox, Safari Plug-in, and/or the like APIs), and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Also, in place of a Web browser and information server, a combined application may be developed to perform similar operations of both. The combined application would similarly affect the obtaining and the provision of information to users, user agents, and/or the like from the AILCT™ embodiments enabled nodes. The combined application may be nugatory on systems employing standard Web browsers.

### Mail Server

A mail server component 921 is a stored program component that is executed by a CPU 903. The mail server may be a conventional Internet mail server such as, but not limited to sendmail, Microsoft Exchange, and/or the like. The mail server may allow for the execution of program components through facilities such as ASP, ActiveX, (ANSI) (Objective-) C (++), C# and/or .NET, CGI scripts, Java, JavaScript, PERL, PHP, pipes, Python, WebObjects, and/or the like. The mail server may support communications protocols such as, but not limited to: Internet message access protocol (IMAP), Messaging Application Programming Interface (MAPI)/Microsoft Exchange, post office protocol (POP3), simple mail transfer protocol (SMTP), and/or the like. The mail server can route, forward, and process incoming and outgoing mail messages that have been sent, relayed and/or otherwise traversing through and/or to the AILCT™ embodiments.

Access to the AILCT™ embodiments mail may be achieved through a number of APIs offered by the individual Web server components and/or the operating system.

Also, a mail server may contain, communicate, generate, obtain, and/or provide program component, system, user, and/or data communications, requests, information, and/or responses.

### Mail Client

A mail client component 922 is a stored program component that is executed by a CPU 903. The mail client may be a conventional mail viewing application such as Apple Mail, Microsoft Entourage, Microsoft Outlook, Microsoft Outlook Express, Mozilla, Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

### Cryptographic Server

A cryptographic server component 920 is a stored program component that is executed by a CPU 903, cryptographic processor 926, cryptographic processor interface 927, cryptographic processor device 928, and/or the like. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash operation), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the AILCT™ embodiments may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for an digital audio file. A cryptographic component may communicate to and/or with other components in a component collection, including itself, and/or facilities of the like. The cryptographic component supports encryption schemes allowing for the secure transmission of information across a communications network to enable the AILCT™ embodiments component to engage in secure transactions if so desired. The cryptographic component facilitates the secure accessing of resources on the AILCT™ embodiments and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

### The AILCT™ Database

The AILCT™ database component 919 may be embodied in a database and its stored data. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the AILCT™ database may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of capabilities encapsulated within a given object. If the AILCT™ database is implemented as a data-structure, the use of the AILCT™ database 919 may be integrated into another component such as the AILCT™ embodiments component 935. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database component 919 includes several tables 919a-d. A personnel table 919a includes fields such as, but not limited to: a personnel_ID, personnel_company_ID_number, personnel_name, personnel_type, personnel_company, personnel_tickets, and/or the like. The personnel table may support and/or track multiple entity accounts on the AILCT™ embodiments. A tickets table 919b includes fields such as, but not limited to: ticket_ID, ticket_priority, ticket_timestamp, ticket_due_date, ticket_status, ticket_company, ticket_title, ticket_value, ticket_supervisors, ticket_assignee, ticket_key, and/or the like. The ticket table may track and/or store multiple tickets created on the AILCT™ embodiments. A transactions table 919c includes fields such as, but not limited to: transaction_ID, transaction_payee, transaction_payer, transaction_timestamp, transaction_amount, transaction_billing_info, transaction_relevant_ticket, and/or the like. An expected_info table 919d includes fields such as, but not limited to: expected_info_ID, expected_info_relevant_tickets, and/or the like. Similarly, other data fields can be provided to implement any other embodiment described herein. Such data can include, but is not limited to, GPS coordinates of a service provider or customer, a price for goods or description of goods, an expiration time, a description of a legal or regulatory violation, an individual submitting traffic violation information, a description of services to be performed, and the like.

In some embodiments, the AILCT™ database may interact with other database systems. For example, employing a distributed database system, queries and data access by search AILCT™ component may treat the combination of the AILCT™ database, an integrated data security layer database as a single database entity.

In one embodiment, user programs may contain various user interface primitives, which may serve to update the AILCT™ embodiments. Also, various accounts may require custom database tables depending upon the environments and the types of clients the AILCT™ embodiments may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components 919a-d. The AILCT™ embodiments may be configured to keep track of various settings, inputs, and parameters via database controllers.

The AILCT™ database may communicate to and/or with other components in a component collection, including itself, and/or facilities of the like. Most frequently, the AILCT™ database communicates with the AILCT™ component, other program components, and/or the like. The database may contain, retain, and provide information regarding other nodes and data.

### The AILCT™ Component

The AILCT™ component 935 is a stored program component that is executed by a CPU. In one embodiment, the AILCT™ component incorporates any and/or all combinations of the aspects of the AILCT™ embodiments that were discussed in the previous figures or other portions of the present disclosure. As such, the AILCT™ embodiments affect accessing, obtaining and the provision of information, services, transactions, and/or the like across various communications networks.

The AILCT™ embodiments transform ticket and user inputs via AILCT components 941-945 and 919a-d into payment and work product outputs.

In one embodiment, the AILCT component 935 takes inputs as discussed in the disclosure above, and transforms the inputs via various components (e.g., Component 941, Component 942, Component 943), into outputs. Each of the aforementioned components may correspond to various aspects described herein, such as pre-processing queries, sending query components to local and remote LLMs for processing.

The AILCT™ embodiments component enabling access of information between nodes may be developed by employing standard development tools and languages such as, but not limited to: Apache components, Assembly, ActiveX, binary executables, (ANSI) (Objective-) C (++), C# and/or.NET, database adapters, CGI scripts, Java, JavaScript, mapping tools, procedural and object oriented development tools, PERL, PHP, Python, shell scripts, SQL commands, web application server extensions, web development environments and libraries (e.g., Microsoft's ActiveX; Adobe AIR, FLEX & FLASH; AJAX; (D) HTML; Dojo, Java; JavaScript; jQuery (UI); MooTools; Prototype; script.aculo.us; Simple Object Access Protocol (SOAP); SWFObject; Yahoo! User Interface; and/or the like), WebObjects, and/or the like. In one embodiment, the AILCT™ server employs a cryptographic server to encrypt and decrypt communications. The AILCT™ component may communicate to and/or with other components in a component collection, including itself, and/or facilities of the like. Most frequently, the AILCT™ component communicates with the AILCT™ database, operating systems, other program components, and/or the like. The AILCT™ embodiments may contain, communicate, generate, obtain, and/or provide program component, system, user, and/or data communications, requests, and/or responses.

### Distributed AILCT Embodiments

The structure and/or operation of any of the AILCT™ node controller components may be combined, consolidated, and/or distributed in any number of ways to facilitate development and/or deployment. Similarly, the component collection may be combined in any number of ways to facilitate deployment and/or development. To accomplish this, one may integrate the components into a common code base or in a facility that can dynamically load the components on demand in an integrated fashion.

The component collection may be consolidated and/or distributed in countless variations through standard data processing and/or development techniques. Multiple instances of any one of the program components in the program component collection may be instantiated on a single node, and/or across numerous nodes to improve performance through load-balancing and/or data-processing techniques. Furthermore, single instances may also be distributed across multiple controllers and/or storage devices; e.g., databases. All program component instances and controllers working in concert may do so through standard data processing communication techniques.

The configuration of the AILCT™ controller will depend on the context of system deployment. Factors such as, but not limited to, the budget, capacity, location, and/or use of the underlying hardware resources may affect deployment requirements and configuration. Regardless of if the configuration results in more consolidated and/or integrated program components, results in a more distributed series of program components, and/or results in some combination between a consolidated and distributed configuration, data may be communicated, obtained, and/or provided. Instances of components consolidated into a common code base from the program component collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If component collection components are discrete, separate, and/or external to one another, then communicating, obtaining, and/or providing data with and/or to other component components may be accomplished through inter-application data processing communication techniques such as, but not limited to: Application Program Interfaces (API) information passage; (distributed) Component Object Model ((D) COM), (Distributed) Object Linking and Embedding ((D) OLE), and/or the like), Common Object Request Broker Architecture (CORBA), Jini local and remote application program interfaces, JavaScript Object Notation (JSON), Remote Method Invocation (RMI), SOAP, process pipes, shared files, and/or the like. Messages sent between discrete component components for inter-application communication or within memory spaces of a singular component for intra-application communication may be facilitated through the creation and parsing of a grammar. A grammar may be developed by using development tools such as lex, yacc, XML, and/or the like, which allow for grammar generation and parsing capabilities, which in turn may form the basis of communication messages within and between components.

For example, a grammar may be arranged to recognize the tokens of an HTTP post command, e.g.:
w3c-post http:// . . . Value1
where Value1 is discerned as being a parameter because “http://” is part of the grammar syntax, and what follows is considered part of the post value. Similarly, with such a grammar, a variable “Value1” may be inserted into an “http://” post command and then sent. The grammar syntax itself may be presented as structured data that is interpreted and/or otherwise used to generate the parsing mechanism (e.g., a syntax description text file as processed by lex, yacc, etc.). Also, once the parsing mechanism is generated and/or instantiated, it itself may process and/or parse structured data such as, but not limited to: character (e.g., tab) delineated text, HTML, structured text streams, XML, and/or the like structured data. In another embodiment, inter-application data processing protocols themselves may have integrated and/or readily available parsers (e.g., JSON, SOAP, and/or like parsers) that may be employed to parse (e.g., communications) data. Further, the parsing grammar may be used beyond message parsing, but may also be used to parse: databases, data collections, data stores, structured data, and/or the like. Again, the desired configuration will depend upon the context, environment, and requirements of system deployment.

For example, in some implementations, the AILCT™ controller may be executing a PHP script implementing a Secure Sockets Layer (“SSL”) socket server via the information server, which listens to incoming communications on a server port to which a client may send data, e.g., data encoded in JSON format. Upon identifying an incoming communication, the PHP script may read the incoming message from the client device, parse the received JSON-encoded text data to extract information from the JSON-encoded text data into PHP script variables, and store the data (e.g., client identifying information, etc.) and/or extracted information in a relational database accessible using the Structured Query Language (“SQL”). An exemplary listing, written substantially in the form of PHP/SQL commands, to accept JSON-encoded input data from a client device via a SSL connection, parse the data to extract variables, and store the data to a database, is provided below:
<? PHP
header (‘Content-Type: text/plain’);
//set ip address and port to listen to for incoming data
$address=‘192.168.0.100’;
$port=255;
//create a server-side SSL socket, listen for/accept incoming communication
$sock=socket_create (AF_INET, SOCK_STREAM, 0);
socket_bind ($sock, $address, $port) or die (‘Can not bind to address’);
socket_listen ($sock);
$client=socket_accept ($sock);
// read input data from client device in 1024 byte blocks until end of message do {
   $input=“ ”;
   $input=socket_read($client, 1024);
   $data.=$input;
} while ($input!=“ ”);
//parse data to extract variables
$obj=json_decode ($data, true);
//store input data in a database
mysql_connect (“201.408.185.132”,$DBserver,$password);//access database server
mysql_select (“CLIENT_DB.SQL”);//select database to append
mysql_query (“INSERT INTO UserTable (transmission)
VALUES ($data)”);//add data to UserTable table in a CLIENT database
mysql_close (“CLIENT_DB.SQL”);//close connection to database
?>

Also, the following resources may be used to provide example embodiments regarding SOAP parser implementation:
http://www.xav.com/perl/site/lib/SOAP/Parser.html
http://publib.boulder.ibm.com/infocenter/tivihelp/v2r1/index.jsp?topic=/com.ibm.IBMDI.doc/referenceguide295.htm

and other parser implementations:
http://publib.boulder.ibm.com/infocenter/tivihelp/v2r1/index.jsp?topic=/com.ibm.IBMDI.doc/referenceguide259.htm
all of which are hereby expressly incorporated by reference.

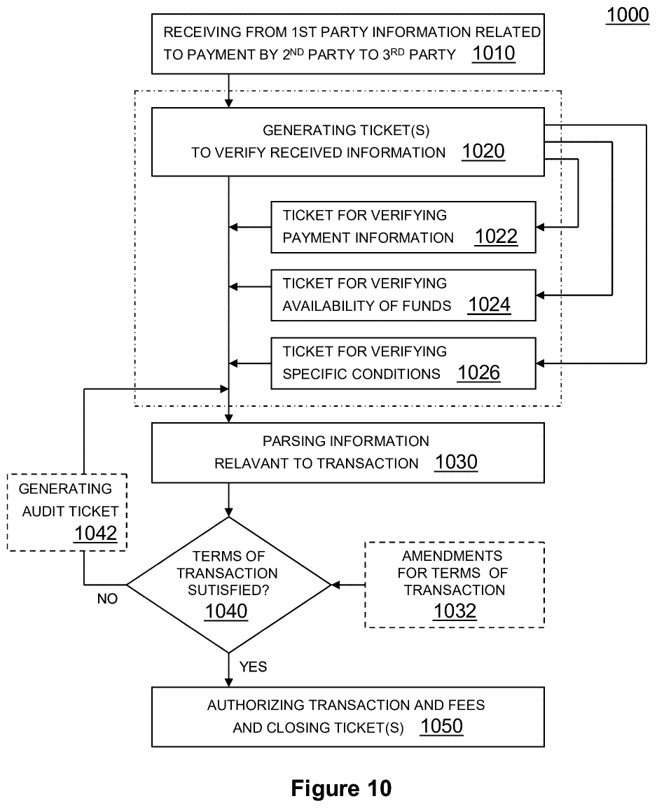

Referring to FIG. 10, there is depicted a high level logical flowchart of a method 1000 for servicing financial transactions using an AI-model driven system (i.e., the AILCT™ system). In broader terms, applications of the method 1000 relate to administration by AI model of the AILCT™ system, as an logistics service provider, of payments performed, via an intermediary (1st party), by a 2nd party to a 3rd party.

The method 1000 can be utilized for servicing financial transactions between and/or within entities or between customers and service providers, among other types of financial transactions. Such transactions and related communications may be performed by mail, fax/phone or via electronic means (i.e., processors and servers connected to communication networks/the Internet) or a combination thereof and, in some instances, may include person-to-person communication. Preferably, these functions are managed and executed by an AI model trained on previous transaction data of the system.

Illustrative examples of the applications of the method 1000 include administration of payments on invoices between the involved parties, mitigation of documental/material discrepancies (e.g., insufficient or erroneous payment amounts, incorrect payee or routing information, and the like) and financial errors (e.g., lack of sufficient funds), and complaint management. In some embodiments, the invoices may relate to payments for shipment of goods, trade services, legal services, investment services, or logistics services. Another representative group of applications relates to management of payments and customer complaints within daily deal systems, such as GroupOn® and LivingSocial® and the like, as well as within booking systems, such as transportation, hotel, entertainment and other booking systems.

In further embodiments, the method 1000 may include administration of payments having specific conditions (e.g., resolution of customer complaints prior to payment initiation, execution of payments in installments, on specific dates, and the like).

Illustrative examples of the transactions include, but not limited to, payments on invoices for services, products, parts, transportation, bookings and reservations, medical treatment and drugs, debt/installment payments, advance/late/conditional payments, among other types of payments.

In the depicted embodiment, at step 1010, a financial transaction is initiated by a 1^{st} party (i.e., client of the AILCT™ system) that forwards to an logistics service provider (i.e., administrator of the AILCT™ system) a message requesting to service (or informing about) a payment to be performed by a 2^{nd} to a 3^{rd} party. The message may be delivered by an electronic means (e.g., via a processor) or any other means of communications, and at least portions of the message may relate to time-sensitive events.

In exemplary applications, the administrator may be an individual (broker, accountant, attorney, trustee, agent, and the like) or an entity utilizing the AILCT™ system such as another human or a suitably trained AI model. Alternatively, at least a portion of functions of the administrator may be performed by a computer program running on a computer(s) accessible by the 1^{st} party.

The received from the 1^{st} party message generally includes payment information (e.g., names and addresses of the involved parties, account/routing number(s), due date(s) and amount(s) of payments, invoice(s) number(s), description of provided/received service(s), AILCT™ processing fee (i.e., remuneration), payment schedule, etc.) or at least pre-determined portions thereof necessary for executing the transaction between these parties.

The funds for the transaction and paying service fees (e.g., to the administrator of the AILCT™ system) may reside at or be credited to an account (or accounts) associated with the administrator of the AILCT™ system. In an alternate embodiment, at least a portion of the funds may be associated with an account (or accounts) of the 1^{st} party.

Generally, a service fee schedule for using the AILCT™ system is agreed upon in advance with the administrator of the system (e.g., based on an amount of the transaction and/or complexity of its execution), and these fees may be charged against pre-selected accounts of one or several involved parties. Remuneration value of the service fees may depend on the value, urgency, and complexity of the transaction, among other factors.

At step 1020, the administrator of the AILCT™ system generates at least one logistics task ticket for verifying elements of the information received from the 1^{st} party. For example, the administrator may generate a logistics task ticket for verifying payment information, availability of funds information, as well as compliance with other terms and conditions of the transaction between by the involved parties.

Alternatively (as depicted in FIG. 10), the administrator of the AILCT™ system may issue several logistics task tickets, each selectively related to a specific task or tasks, e.g., a first logistics task ticket 1022 for verifying the payment information, a second logistics task ticket 1024 for verifying availability of the funds, and a third logistics task ticket 1026 for verifying compliance with other terms and conditions of the transaction.

In other embodiments, a number of the generated logistics task tickets may by either greater or smaller than 3, and the AILCT™ system performs the same processes regardless of a number of the generated logistics task tickets.

Each of the tickets may be posted on the AILCT™ server (discussed in reference to FIGS. 3, 5a-5b, 7, and 9), assign a different level of priority (i.e., placed in queue among other logistics task tickets), and have a plurality of fields selectively corresponding to particular sub-tasks. Level of priority of the logistics task tickets is generally based on their urgency and workload of personnel. The queue may further be adapted and configured to permit the AILCT™ system to select such logistics task tickets or portions thereof for review or completion.

The logistics task tickets may also include attributes stipulating specific processing conditions, such as particular need dates/time, and the like. When such conditions are violated or there is a substantial risk of their violation, the AILCT™ system may generate alarm signals directed to personnel assigned to these ticket(s) and/or the human administrator or AI model trained to manage the system.

At step 1030, the logistics task tickets (illustratively, tickets 1022, 1024, and 1026) are processed, as discussed above in reference to FIGS. 4a-4b, 5a-5b, 6a-6c, 7, and 8a-8b. At least a portion of these tasks may be performed using computers associated the AILCT™ system. In optional embodiments, the AILCT™ system may assign remuneration values for completing a specific logistics task ticket or a portion thereof, as well as offer the ticket or its portions for processing to a winning bidder.

The results of the processing may be presented in tabular, graphical, and other formats. In general, at step 1030, personnel assigned to the logistics task tickets (e.g., one or several administrators of the AILCT™ system or their staff) parses the message received at step 1010, and then extracts relevant reference information from the message and/or the AILCT™ database (discussed in reference to FIGS. 5a-5b, 7 and 9), as well as uses records available from other data depositories.

In some embodiments, information and records of interest may be accessed using mobile computing devices, such as a tablet, a smart phone, and the like. Noticed discrepancies and/or errors are reported to the 1^{st} party for taking corrective actions. In some cases, the 2^{nd} and 3^{rd} parties may also be contacted to resolve the discrepancies and/or errors.

During execution of the logistics task ticket 1024, availability of the funds information is generally verified using records from the respective financial institutions (e.g., banks) that maintain an account (or accounts) to be credited by the 2^{nd} party. Such information may be obtained from bank account servers and other depositories of financial data. In some embodiments, the received from the 1^{st} party information includes pre-selected key words that, when parsed and detected, cause the AILCT™ system to interrogate a bank account server associated with the respective bank account in order to obtain the funds availability or fund transfer information.

Correspondingly, execution of the logistics task ticket 1026 includes verifying satisfaction of the specific condition, if any, for the transaction. Noticed violations, discrepancies and/or errors are reported to and discussed with the involved parties for taking corrective actions.

At step 1040, the method 1000 queries whether the payment information (logistics task ticket 1022) is correct (or has been corrected), the needed funds are available (logistics task ticket 1024) and all other conditions (logistics task ticket 1026) of the transaction have been verified, matched, and/or otherwise positively confirmed.

If the query is answered negatively, the method 1000 proceeds back to step 1030. In a further embodiment, at an optional step 1042, the method 1000 may generate a logistics audit task ticket to investigate whether the distributive on demand service has been completed or to determine reasons for delays in the completion. If the query of step 1040 is answered affirmatively, the method 1000 proceeds to step 1050.

In further embodiments, at optional step 1032, the involved parties may agree to amend the payments schedule or any other terms of the transaction (e.g., in case of insufficiency of funds, parties may agree to installment payments instead of a full payment or to an extended payment schedule, and the like), and these amendments are taken into consideration in queries of step 1040.

At step 1050, the administrator of the AILCT™ system authorizes (i.e., initiates) the requested transaction (i.e., payment to the 3^{rd} party) and the AILCT™ system service fees and closes the logistics task ticket(s) generated at step 1020 and optional step 1042. Typically, the administrator of the AILCT™ system maintains for future reference records of the assignments and clients in the database of the system.

In one illustrative application, the method 1000 is used in a financial services industry for processing, at request of a 1^{st} party (as a client of the AILCT™ system) a payment performed by a 2^{nd} party on an invoice (or bill) from a service provider (or credit card company) as a 3^{rd} party. In this application, the payment can be initiated from an account associated (i.e., under control of) an administrator of the AILCT™ system. At step 1010, the 1^{st} party provides the administrator of the AILCT™ system with information materially relevant to the requested payment and parties involved in the transaction. At step 1020, the administrator of the AILCT™ system generates at least one logistics task ticket for verifying the provided information (e.g., addresses and account information, availability of funds, validity/completion of serviced to be paid for, etc.) and, at step 1130, the ticket(s) is (are) processed. Noticed errors and discrepancies, if any, are reported for resolution to the respective parties. At step 1040, the AILCT™ system queries if all terms of the request of step 1110 have been satisfied and repeats returning to step 1130 until the query is answered affirmatively. Thereafter, the method 1000 proceeds to step 1050, where the AILCT™ system initiates the requested payment and collection of its service fees and then closes the open ticket(s).

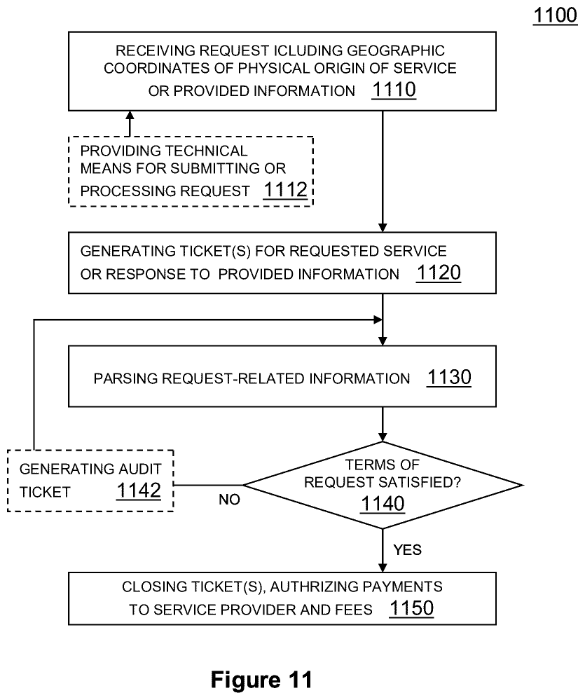

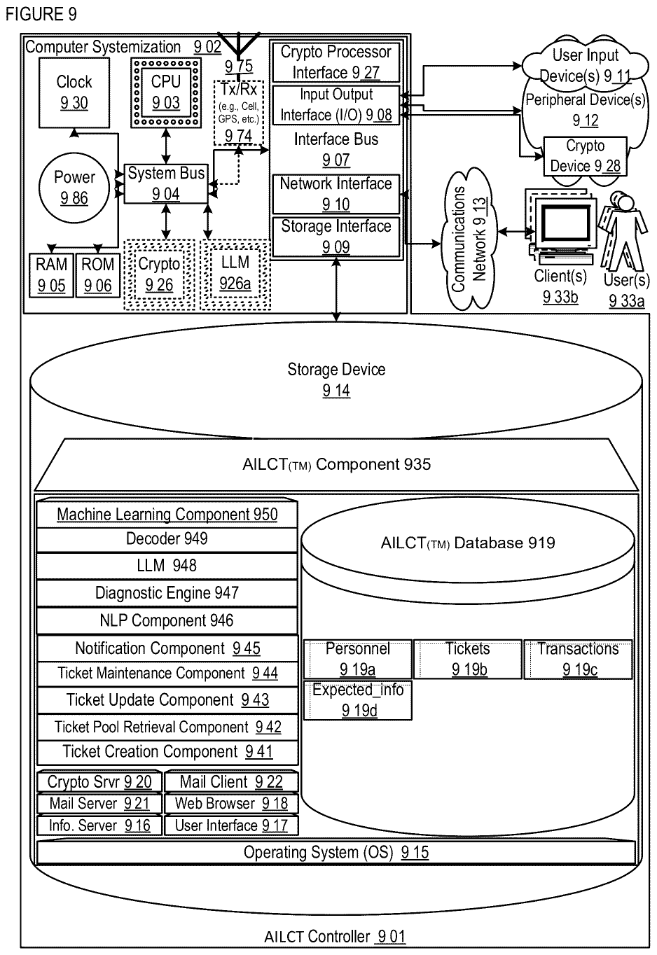

Referring to FIG. 11, there is depicted a high-level logical flowchart of a method 1100 for using a distributive on demand service management system (i.e., the AILCT™ system) for servicing transactions or information exchanges that include geographic coordinates of a physical origin (i.e., location) where particular services were or to be performed or information of interest is/was available or recorded. In broader terms, in applications of the method 1100, the AILCT™ system operates as an intermediary (i.e., logistics service provider that may execute as a trained AI model) between a 1^{st} party (client of the AILCT™ system) and a 2^{nd} party, such as a provider of trade services or a source of provided information associated with a location at specific geographic coordinates (e.g., information related to legal violation or logistics services). Each party may include a combination of one or more human operators and/or trained AI models.

Representative applications of the method 1100 include, but not limited to, trade services (e.g., maintenance and repair services for aircraft, cars, trucks, and other means of transportations, delivery services for people, perishable (food, medicine, flowers, etc.) or imperishable products, locality-bound trade services (e.g., plumbing, mechanic, repair, lawn/landscaping, electrician, carpentry, moving and shipping services, and the like), legal services (reporting on crime or court order violations, trespassing, property damage, littering, zoning, etc. violations) and logistics services, such as collection of customer's critiques and complaints (e.g., to rate customer demands and/or quality of particular services at the identified locations).

Other examples of the logistics services may include verification of information in company records, verification of agreements between service providers, collection of competitive business intelligence, governmental logistics functions such as processing of legal rights, permits, licenses or credit checks, resolution of billing disputes, and technical/online support.

In some implementations, the method 1100 relates to applications that allow an end user (e.g., customer) purchase and/or bid on goods in transit. Such goods may be subject to expiration dates and/or their price may otherwise be a subject to negotiations. For example, in particular embodiments, the method 1100 relates to delivery services which products in transit are subject to expiration dates (e.g., deliveries of prepared foods, flowers, etc.) and the price the products in transit may depend on a duration of the time remaining to the expiration dates and, as such, current geographical locations of the goods, end user, or both.

In the depicted embodiment, at step 1110, an logistics service provider (i.e., administrator of the AILCT™ system, such as a trained AI model) receives from its client (i.e., 1^{st} party) a message containing a request for a particular service or a response (e.g., legal or logistics action, and the like) to the provided information and including geographic coordinates of the location where service should be or was completed or, alternatively, the information relates to or was originated. The message may be received via an electronic means (e.g., processor) or non-electronic means, and at least portions of the message may relate to time-sensitive events or products.

In exemplary applications, the administrator may be an individual (broker, accountant, attorney, trustee, agent, and the like), one or more trained AI models, or an entity utilizing the AILCT™ system. Alternatively, at least a portion of functions of the administrator may be performed by a computer program running on a computer(s) accessible by the 1^{st} party.

At optional step 1112, a technical means for collecting and documenting the information or confirming completion of the service may be provided, in advance, to the requesting party or, alternatively, the administrator of the AILCT™ system. Such a means may include, e.g., an Internet connection, a digital still or video camera, a GPS (Global Positional System) enabled recording device, a mobile computing device such as a tablet or a smart phone, or a combination thereof). For example, such a video camera may be located on a vehicle (e.g., a dash cam) that an operator may use to record a traffic incident and embed location and time information, and provide data that can be used to identify those involved in the incident, such as facial data of those involved sufficient to permit identification via facial recognition software. Similarly, the AILCT system may be configured to access camera data on built-in cameras and other sensors on Tesla® vehicles. A user (human or AI model) can use onboard vehicle camera data to estimate speed of offending speeders, their location and license plate information, and the like, in order to make a report to authorities.

At step 1120, the administrator of the AILCT™ system generates at least one logistics task ticket related to verification and processing of the request of step 1110. Such logistics task ticket(s) are generally saved on the AILCT™ server (discussed in reference to FIGS. 3, 5a-5b, 7, and 9), include fields for relevant sub-tasks, and may be provided with attributes defining their degree of urgency, particular need dates/time, and other specific conditions. When such conditions are violated or there is a substantial risk of their violation, the AILCT™ system may generate alarm signals directed to personnel assigned to these ticket(s) and/or the administrator.

At step 1130, the logistics task ticket(s) generated at step 1120 is (are) processed within the AILCT™ system, as discussed above in reference to FIGS. 4a-4b, 5a-5b, 6a-6c, 7, and 8a-8b. Noticed discrepancies and/or errors are reported to the 1^{st} party for taking corrective actions. In some cases, the 2^{nd} party may also be contacted to resolve the discrepancies and/or errors.

In general, the ticket can be assigned to the logistics task personnel (e.g., one or several administrators of the AILCT™ system or their staff) which parses the message received at step 1110, and then extracts relevant reference information from the message and/or the AILCT™ database (discussed in reference to FIGS. 5a-5b, 7 and 9), as well as uses records available from other data depositories to verify validity, terms, conditions and status of the service or received information. In some embodiments, information and records of interest may be accessed using mobile computing devices, such as a tablet, a smart phone, and the like.

In optional embodiments, the AILCT™ system may assign remuneration values for completing a logistics task ticket or a portion thereof, as well as offer the ticket or its portions for processing to a winning bidder. At least a portion of these tasks may be performed using computers associated the AILCT™ system.

Retrieved reference data generally includes (i) a description of the distributive on demand service or a description of the provided information, and (ii) the geographic coordinates of a location where the service was completed or the information was recorded. In further embodiments, the completion data may also include an amount of time expected and/or actually spent by the service provider at the identified location.

The results of the processing may be presented in tabular, graphical, and other formats. Noticed discrepancies and/or errors are reported to the 1^{st} party for taking corrective actions. In some cases, the 2^{nd} party may also be contacted to resolve the discrepancies and/or errors.

Illustrative examples of provided services include ordering deliveries to or repairs at particular location identified by their geographic coordinates and control over their completion. When such deliveries relate to perishable goods (e.g., pizza, flowers, etc.) or time-sensitive services, the AILCT™ system may determine or negotiate their prices as a function of the time remaining to the respective expiration or due dates. In some embodiments, the administrator of the AILCT™ system may be given the authority to penalize the 2^{nd} party for the confirmed legal violations and/or reward the reporting party (e.g., 1^{st} party) for the provided information. Trained AI models can be used to carry out such transactions in real time to prevent the need for human operator input.

Correspondingly, illustrative examples of the received information may include records of violations (e.g., picture evidence of crime, parking or zoning violations, trespassing, property damage, etc.) at the identified locations, whereas logistics services may relate to responses on customer's critiques and complaints at these locations.

At step 1140, the method 1100 queries whether all terms and conditions of the request of step 1110 are verified, matched, and/or positively confirmed. In particular, the method 1100 compares the distributive on demand service completion records or responses to the provided information with the distributive on demand service data to determine if the geographic coordinates of the physical origin of the distributive on demand service completion records or provided information comport with the geographic coordinates of the location where the distributive on demand service was completed or the information recorded. If the query is answered negatively, the method 1100 proceeds back to step 1130. If the query of step 1140 is answered affirmatively, the method 1000 proceeds to step 1150.

In a further embodiment, at an optional step 1142, the method 1100 may generate a logistics audit task ticket to investigate whether the distributive on demand service has been completed or a response to the provided information has been received, or to determine reasons for delays in the completion or expected response.

Illustrative examples of confirmed completion of performed services or responses to the provided information identified by their geographic coordinates communicated at step 1110, include verification of deliveries to or repairs performed at these location(s) by picture evidences, confirmation receipt(s) or reports from corresponding authorities, photographs taken at or proximate to the locations identified by their geographic coordinates, and witness testimonies, among other documents or articles of graphical evidence.

At step 1150, the administrator of the AILCT™ system closes the ticket(s) generated at 1120, authorizes (i.e., initiates) the AILCT™ processing fee and, if requested by the 1^{st} party, payments to service providers, as well as payments (e.g., awards) to the sources of provided information. The payments to the service providers are generally contractual or otherwise negotiated sums.

Alternatively or additionally, these payments at least in part may be determined by weather conditions, season, specific dates (e.g., weekdays, weekend, holidays), time spent for completing the assignment, among other materially relevant conditions and circumstances. The AILCT™ processing fees (i.e., remuneration) are generally agreed upon in advance by the 1^{st} party and the administrator or alternatively, by all parties involved, and may depend on urgency and the scope of the assignment. Typically, the administrator of the AILCT™ system maintains for future reference records of the assignments and clients in the database of the system.

In one illustrative application, the method 1100 is used in a food industry for delivery comestible products, such as pizza. A comestible product can be assigned a profile or other data describing the product (e.g., type, size, toppings, etc.), and applicable regulatory requirements (e.g., time stamp of when the pizza was cooked, price, and expiration date), and the product or its delivering vehicle may be provided with means (e.g., GPS marker or tracking device) providing, in real time, tracking of their current geographical location. At step 1110, a 1^{st} party (e.g., client of the AILCT™ system) may place with an administrator of the AILCT™ system a request for negotiating the price and ordering a particular pizza and delivering it, by a specific time, to a location at particular geographic coordinates. At step 1120, the administrator of the AILCT™ system generates at least one logistics task ticket related to verification and processing of the request of step 1110 and, at step 1130, the ticket(s) are processed. In particular, the AILCT™ system verifies the description of the product and its compliance with the regulatory requirements, ability of the delivery service to meet the delivery schedule, negotiates the price for the service (e.g. with a driver or a pizza cooking facility). Then, the AILCT™ system places the order and verifies its completion (i.e., timely delivery of the ordered pizza to the location at the identified geographic coordinates). When some instructions of the 1^{st} party cannot be met, the AILCT™ system contacts the 1^{st} party for additional instructions and inquires whether available terms are acceptable to the 1^{st} party. At step 1140, the AILCT™ system queries if all terms of the original or amended request of step 1110 have been satisfied and repeats returning to step 1130 until the query is answered affirmatively. Thereafter, the method 1100 proceeds to step 1150, where the AILCT™ system closes the open ticket(s) and initiates payment for the delivered pizza and collection of its service fees.

In another illustrative application, the method 1100 is used for reporting on automotive-related legal violations, such as parking, speeding, running a red light, changing lanes without signaling or driving under the influence of alcohol or controlled substance violations as defined by the respective laws or regulations. At step 1110, a 1^{st} party (e.g., client of the AILCT™ system) provides an administrator of the AILCT™ system with information related to recorded legal violation at a location identified by its geographic coordinates and requests to follow up on the information. Such documented information may be originated by a person using a GPS-enabled recording device or, alternatively, by an automatic recording apparatus. At step 1120, the administrator of the AILCT™ system generates at least one logistics task ticket for verifying the provided information and monitoring processing of the information by the respective authorities (e.g., the Police, Motor Vehicle Department, etc.) and, at step 1130, the ticket(s) are processed. In particular, the AILCT™ system verifies facts relevant to the reported violation, forwards the confirmed information to the authorities, and follows up on the provided information until receiving their response. The AILCT™ system may also contact the 1^{st} party or the authorities for additional information and/or clarifications. At step 1140, the AILCT™ system queries if all terms of the request of step 1110 have been satisfied and repeats returning to step 1130 until the query is answered affirmatively. Thereafter, the method 1100 proceeds to step 1150, where the AILCT™ system closes the open ticket(s) and initiates collection of its service fees and, when authorized, payment of optional awards payment for reporting on the legal violation.

In order to address various issues and advance the art, the entirety of this application (including the Cover Page, Title, Headings, Field, Background, Summary, Brief Description of the Drawings, Detailed Description, Claims, Abstract, Figures, Appendices, and otherwise) shows, by way of illustration, various embodiments in which the claimed innovations may be practiced. The advantages and features of the application are of a representative sample of embodiments only, and are not exhaustive and/or exclusive. They are presented only to assist in understanding and teach the claimed principles. It should be understood that they are not representative of all claimed innovations. As such, certain aspects of the disclosure have not been discussed herein. That alternate embodiments may not have been presented for a specific portion of the innovations or that further undescribed alternate embodiments may be available for a portion is not to be considered a disclaimer of those alternate embodiments. It will be appreciated that many of those undescribed embodiments incorporate the same principles of the innovations and others are equivalent. Thus, it is to be understood that other embodiments may be utilized and functional, logical, operational, organizational, structural and/or topological modifications may be made without departing from the scope and/or spirit of the disclosure. As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the innovations, and inapplicable to others. In addition, the disclosure includes other innovations not presently claimed. Applicant reserves all rights in those presently unclaimed innovations including the right to claim such innovations, file additional applications, continuations, continuations in part, divisions, and/or the like thereof. As such, it should be understood that advantages, embodiments, examples, functional, features, logical, operational, organizational, structural, topological, and/or other aspects of the disclosure are not to be considered limitations on the disclosure as defined by the claims or limitations on equivalents to the claims. It is to be understood that, depending on the particular needs and/or characteristics of a AILCT™ embodiments individual and/or enterprise user, database configuration and/or relational model, data type, data transmission and/or network framework, syntax structure, and/or the like, various of the AILCT™ embodiments, may be implemented that enable a great deal of flexibility and customization. For example, aspects of the AILCT™ embodiments may be adapted for reporting incidents to authorities.

For example, a user can take a picture of a ticketable offense, such as illegal parking, a car missing a license plate, and/or the like, using his mobile device. The mobile device may attach EXIF data to the photo, including the date and location where it was taken. The user may then be able to send the photo to a local police station, Department of Motor Vehicles, and/or a like office, where a ticket may be created to verify the violation. If the violation appears valid, personnel may either issue a warning, ticket, and/or like punishment to the party committing the offense, based on information present in the user's photograph, or may contact the user in order to obtain more information about the part committing the offense, such as the license plate of the car, and/or like information. A similar system may also be used to report general crimes, to speed up the process of dialing 911, and/or a similar purpose.

All statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Descriptions herein of circuitry and method steps and computer programs represent conceptual embodiments of illustrative circuitry and software embodying the principles of the disclosed embodiments. Thus the functions of the various elements shown and described herein may be provided through the use of dedicated hardware as well as hardware capable of executing software in association with appropriate software, such as suitably trained AI models as set forth herein.

In the disclosure hereof any element expressed as a means for performing a specified function is intended to encompass any way of performing that function including, for example, a) a combination of circuit elements and associated hardware which perform that function or b) software in any form, including, therefore, firmware, microcode or the like as set forth herein, combined with appropriate circuitry for executing that software to perform the function. Applicants thus regard any means which can provide those functionalities as equivalent to those shown herein.

Similarly, it will be appreciated that the system and process flows described herein represent various processes which may be substantially represented in computer-readable media and so executed by a computer or processor, whether or not such computer or processor is explicitly shown. Moreover, the various processes can be understood as representing not only processing and/or other functions but, alternatively, as blocks of program code that carry out such processing or functions.

The methods, systems, computer programs and mobile devices of the present disclosure, as described above and shown in the drawings, provide for improved approaches for managing tasks. It will be apparent to those skilled in the art that various modifications and variations can be made in the devices, methods, software programs and mobile devices of the present disclosure without departing from the spirit or scope of the disclosure. Thus, it is intended that the present disclosure include modifications and variations that are within the scope of the subject disclosure and equivalents.

What is claimed is:

1. An AI-model based method for logistics management, comprising:
a) receiving a shipment information message relating to a shipment via at least one trained AI model, the shipment information message including details for shipping goods to a predetermined geographic location;
b) assigning the shipment via the at least one trained AI model to a shipper for completion via a trained AI model;
c) receiving verification information from the shipper via the at least one trained AI model, the verification information including an electronic message sent by the shipper including geo-coordinates of the shipper at the time the shipment is completed by the shipper;
d) parsing the verification information via the trained AI model;
e) analyzing the verification information via the trained AI model to determine if the geo-coordinates indicate that the verification information was generated at the geographic service location; and
f) sending a message confirming delivery of the shipment based on the verification information.
